(19) United States
(12) Patent Application Publication
(10) Pub. No.: US 2005/0259282 A1
(43) Pub. Date: Nov. 24, 2005

(54) Image processing method, image processing apparatus, image recording apparatus, and image processing program

(75) Inventors: Hiroaki Takano, Tokyo (JP); Tsukasa Ito, Tokyo (JP); Takeshi Nakajima, Tokyo (JP); Daisuke Sato, Tokyo (JP)

Correspondence Address: COHEN, PONTANI, LIEBERMAN & PAVANE, 551 FIFTH AVENUE, SUITE 1210, NEW YORK, NY, 10176, US

(73) Assignee: Konica Minolta Photo Imaging, Inc., Tokyo (JP)

(21) Appl. No.: 11/125,638

(22) Filed: May 10, 2005

(30) Foreign Application Priority Data
May 18, 2004 (JP) JP2004-147797

(51) Int. Cl. H04N 1/56; H04N 1/58; H04N 1/60

(52) U.S. Cl. 358/1.9; 358/506; 382/162; 358/527; 358/520

(57) ABSTRACT

An image processing method includes the steps of: an occupation ratio calculating step of dividing a photographed image data into a plurality of regions based on at least one combination of: predefined brightness and hue; and distance from a frame edge of the photographed image and brightness; and calculating a occupation ratio of each of the plurality of regions which represents a ratio of each of the plurality of regions in the whole photographed image data; an index calculating step of calculating an index determining a type of a photographed scene by multiplying the occupation ratio of each of the plurality of area calculated in the occupation ratio calculation step to a predefined index according to a photographing condition; an image processing condition determining step of determining an image processing condition for the photographed image data using the index calculated in the index calculating step.

This application is based on Japanese Patent Application No. 2004-147797 filed on May 18, 2004 in Japanese Patent Office, the entire content of which is hereby incorporated by reference.

### FIELD OF THE INVENTION

The present invention relates to an image processing method, an image processing apparatus, an image recording apparatus that forms image on an output medium, and an image processing program.

### BACKGROUND OF THE INVENTION

Conventionally, the luminance of a scanned film image or digital camera image has been corrected in such a manner that the average luminance of the whole image is corrected to a level user specifies. In ordinary photography, since the light source condition varies frequently among front light, backlight, strobe-light and so on, and hence a large region having remarkable deviated luminance is caused on an image, a correction using a value calculated by discriminant analysis and multiple regression analysis is needed in addition to the correction of average luminance. However, utilization of the discriminant and regression analysis involves a problem that it is difficult to discriminate a photographed scene because the parameter calculated from a strobe-light scene is very much similar to that from a backlight scene.

A method of calculating an additional correction variable instead of the discriminant and regression analysis method is disclosed in the Patent Document 1. The method disclosed in the Patent Document 1 is to calculate average luminance by using a luminance histogram that represents the accumulated number of pixels (frequency) of luminance, eliminating high-luminance region and low-luminance region from it and further limiting its frequency and obtain a correction value from the difference between the average and reference luminance.

A method of discriminating the light source condition of photography so as to compensate the extraction accuracy of face region is disclosed in the Patent Document 2. The method disclosed in the Patent Document 2 is to extract a face candidate region firstly and calculate the deviation of the average luminance of the extracted face candidate region from the whole image, and then, if the deviation is excessive, discriminate the photographed scene (backlight photography or strobe-light photography) and adjust the allowance of the judgment criterion for the face region. As the method of extracting the face candidate region, a method of using a two-dimensional histogram of hue and saturation as disclosed in the Japanese Application Patent Laid-open Publication No. HEI 6-67320 (1995) and a method of pattern matching or pattern searching as disclosed in the Japanese Application Patent Laid-open Publication Nos. HEI 8-122944 (1996), HEI 8-184925 (1996) and HEI 9-138471 (1997) are cited.

In the Patent Document 2, as a method of eliminating the background region excluding face, a method of discriminating the region by utilizing the ratio of straight portion, line symmetry, ratio of contact with screen edges, density contrast, density change pattern, or periodicity as disclosed in the Japanese Application Patent Laid-open Publication Nos. HEI 8-122944 (1996) and HEI 8-184925 (1996) is cited. As a method of discriminating a photographed scene, a method using a one-dimensional histogram of density is disclosed. This method is based on a rule of thumb that the face region becomes dark and background region becomes clear in case of backlight photography and that the face region becomes clear and background region becomes dark in case of strobe-light and close-up photography.
[Patent Document 1] Japanese Application Patent Laid-open Publication No. 2002-247393
[Patent Document 2]. Japanese Application Patent Laid-open Publication No. 2000-148980.

However, the prior art disclosed in the Patent Document 1 involves a problem that, although the effect of a region having remarkable deviation of luminance is reduced, the brightness of the face region becomes improper in case of a photographed scene where the major object is human body. In addition, the prior art disclosed in the Patent Document 2 involves a problem that, although an effect of compensation in identifying the face region is achieved in a typical backlight or strobe-light and close-up photography, the compensation effect is difficult to be produced if the photography is not based on a typical composition.

### SUMMARY OF THE INVENTION

An object of the present invention is to improve the brightness reproducibility of object by calculating an index that quantitatively represents the photographed scene (light source condition) of photographed image data and determining the image processing condition based on the calculated index.

In order to achieve the above object, an embodiment of the present invention provides an image processing method of processing a set of image data corresponding to one frame of image, including the steps of: an occupation ratio calculating step of dividing the set of photographed image data into a plurality of regions based on at least one combination of a first combination of predefined brightness and hue; and a second combination of distance from a frame edge of the photographed image and brightness; and calculating occupation ratios which represent an occupation ratio of each of the plurality of regions in the whole of the set of photographed image data; an index calculating step of calculating an index determining a type of photographed scene by multiplying each of the occupation ratio calculated in the occupation ratio calculation step by respective coefficients predefined based on photographing conditions; an image processing condition determining step of determining an image processing condition for the set of photographed image data based on the index calculated in the index calculating step.

### BRIEF DESCRIPTION OF DRAWINGS

FIG. 1 is a perspective view showing the external construction of an image recording apparatus according to the embodiment of the present invention.

FIG. 2 is a block diagram showing the internal construction of the image recording apparatus of the embodiment.

FIG. 3 is a block diagram showing the internal construction of the image processor in FIG. 2.

FIG. 4 is a block diagram showing the internal construction of the scene discriminator and internal construction of the ratio calculator.

FIG. 5 is a flowchart showing the scene discrimination by the image adjustment processor.

FIG. 6 is a flowchart showing the occupation ratio calculation for calculating the first occupation ratio for every brightness and hue region.

FIG. 7 is a figure showing an example conversion program from RGB to the HSV color system.

FIG. 8 is a diagram showing a brightness (V)-hue (H) plane and the region r1 and region r2 on the V-H plane.

FIG. 9 is a diagram showing a brightness (V)-hue (H) plane and the region r3 and region r4 on the V-H plane.

FIG. 10 is a diagram showing a curve representing the first coefficient to be multiplied to the first occupation ratio for calculating the index 1.

FIG. 11 is a diagram showing a curve representing the second coefficient to be multiplied to the first occupation ratio for calculating the index 2.

FIG. 12 is a flowchart showing the occupation ratio calculation for calculating the second occupation ratio based on the composition of the photographed image data.

FIG. 13 is a diagram showing the regions n1 to n4 to be determined in accordance with the distance from the frame edge of the photographed image data screen.

FIG. 14 is a diagram showing a curve, representing the third coefficient to be multiplied to the second occupation ratio for calculating the index 3, in each region (n1 to n4).

FIG. 15 is a diagram showing the plotted index 4 and index 5 calculated for each photographing condition (frontal light, strobe-light, and backlight).

FIGS. 16(a), 16(b) and 16(c) are diagrams showing the frequency distribution (histogram) of luminance, normalized histogram, and histogram divided into blocks respectively.

FIGS. 17(a) and 17(b) are figures explaining the elimination of high-luminance region and low-luminance region from the luminance histogram, and FIGS. 17(c) and 17(d) are figures explaining limitation of the luminance frequency.

FIG. 18 is a diagram showing a gradation conversion curve representing the image processing condition (gradation conversion condition) in case the photographed scene is under backlighting condition.

### DETAILED DESCRIPTION OF THE PRESENT INVENTION

Item 1

An image processing method of processing a set of image data corresponding to one frame of image, includes the steps of: an occupation ratio calculating step of dividing the set of photographed image data into a plurality of regions based on at least one combination of a first combination of predefined brightness and hue; and a second combination of distance from a frame edge of the photographed image and brightness; and calculating occupation ratios which represent an occupation ratio of each of the plurality of regions in the whole of the set of photographed image data;
an index calculating step of calculating an index determining a type of photographed scene by multiplying the occupation ratios calculated in the occupation ratio calculation step by coefficients predefined based on photographing conditions for the respective plurality of regions;
an image processing condition determining step of determining an image processing condition for the set of photographed image data based on the index calculated in the index calculating step.
   Item 2

According to image processing method of item 1, the occupation ratio calculating step divides the set of photographed image data into a plurality of regions based on a combination of predefined brightness and hue and calculates occupation ratios which represent an occupation ratio of each of the plurality of regions in a whole of the set of photographed image data and
the index calculating step calculates the index based on at least one of: coefficients in which a coefficient for a region including a predefined high-brightness region and a skin-colored hue region and a coefficient for a region excluding a hue region of the region including the predefined high-brightness region and the skin-colored hue region have different signs from each other; and coefficients in which a coefficient for a region including a predefined middle-brightness region and the skin-colored hue region and a coefficient for a region excluding the predefined middle-brightness region; have different signs from each other.
   Item 3

According to the image processing method of item 2, wherein the index calculating step uses the coefficients in which the coefficient for the region including the predefined high-brightness region and the skin-colored hue region and
the coefficient for the region excluding the hue region of the region including the predefined high-brightness region and the skin-colored hue region have different signs from each other.
   Item 4

According to the image processing method of item 2, the index calculating step uses the coefficients in which the coefficient for the region including the predefined middle-brightness region and the skin-colored hue region and the coefficient for the region excluding the predefined middle-brightness region; have different signs from each other.

Item 5

According to the image processing method of item 2, the index calculating step calculates a first index using coefficients in which the coefficient for the region including the predefined high-brightness region and the skin-colored hue region and the coefficient for the region excluding a hue region of the region including the predefined high-brightness region and the skin-colored hue region have different signs from each other, and calculates a second index using coefficients in which the coefficient for the region including the predefined middle-brightness region and the skin-colored hue region and the coefficient for the region excluding the predefined middle-brightness region have different signs from each other, and the image processing condition determining step determines the image processing condition based on the first index and the second index calculated in the index calculating step.

Item 6

The image processing method of any one of items 2-5, further includes: a histogram generating step of generating a two dimensional histogram by calculating accumulated numbers of pixels of the set of photographed image data for respective combinations of predefined hue and brightness, wherein the occupation ratio calculating step calculates the occupation ratios based on the two dimensional histogram.

Item 7

According to the image processing method of any one of items 2, 3, 5 and 6, the region excluding the hue region of the region including the predefined high-brightness region and the skin-colored hue region whose coefficient has a different sign from the coefficient of the region including the predefined high-brightness region and a skin-colored hue region has a brightness region which is the predefined high-brightness region.

Item 8

According to the image processing method of any one of items 2, 4, 5 and 6, the region excluding the predefined middle-brightness region whose coefficient has a different sign from the coefficient of the region including the predefined middle-brightness region and the skin-colored hue region has a hue region which is within the skin-colored hue region.

Item 9

According to the image processing method of any one of items 2, 3, 5 to 7, the region including the predefined high-brightness region and the skin-colored hue region includes a region whose brightness value in HSV color system is in a range of 170 to 224.

Item 10

According to the image processing method of any one of items 2, 4 to 6 and 8, the region including the predefined middle-brightness region includes a region whose brightness value in HSV color system is in a range of 85 to 169.

Item 11

According to the image processing method of any one of items 2, 3, 5 to 7 and 9, the region excluding the predefined high-brightness region and the skin-colored hue region has a hue region including at least one of a blue hue region and a green hue region.

Item 12

According to the image processing method of any one of items 2, 4 to 6, 8 and 10, the region excluding the predefined middle-brightness region is a shadow region.

Item 13

According to the image processing method of item 11, a brightness value in HSV color system of the blue hue region is in a range of 161 to 250 and a brightness value in HSV color system of the green hue region is in a range of 40 to 160.

Item 14

According to the image processing method of item 12, a brightness value in HSV color system of the shadow region is in a range of 26 to 84.

Item 15

According to the image processing method of any one of items 2 to 14, a hue value in HSV color system of the skin-colored hue region is in a range of 0 to 39 and 330 to 359.

Item 16

According to the image processing method of any one of items 2 to 15, the skin colored hue region is divided into two regions by a predefined conditional expression based on brightness and saturation.

Item 17

According to the image processing method of item 1, the occupation ratio calculating step
divides a set of photographed image data into a plurality of regions based on a combination of distance from an frame edge of the set of photographed image data and brightness and
calculates an occupation ratios which represent a occupation ratio of each of the plurality of regions in a whole of the set of photographed image data and
the index calculating step calculates the index based on coefficients having different values according to distance from the frame edge.
   Item 18

The image processing method of item 17, further includes: a histogram generating step of generating a two dimensional histogram by calculating accumulated numbers of pixels of the set of photographed image data for respective combinations of predefined hue and brightness, wherein the occupation ratio calculating step calculates the occupation ratios based on the two dimensional histogram.

Item 19

According to the image processing method of item 1, the occupation ratio calculating step divides the set of photographed image data into a plurality of regions based on a combination of predefined brightness and hue, calculates first occupation ratios which represent an occupation ratio of each of the plurality of regions in a whole of the set of photographed image data, divides the set of photographed image data into a plurality of regions based on a combination of distance from a frame edge of the set of photographed image data and brightness and calculates second occupation ratios which represent an occupation ratio of each of the plurality of regions in a whole of the set of photographed image data,
the index calculating step calculates the index determining a type of photographed scene by multiplying each of the first and second occupation ratios calculated in the occupation ratio calculation step by each of coefficients predefined based on photographing conditions,
the index calculating step further calculates: a first index using coefficients in which the coefficient for the region including the predefined high-brightness region and the skin-colored hue region and the coefficient for the region excluding a hue region of the region including the predefined high-brightness region and the skin-colored hue region have different signs from each other; a second index using coefficients in which coefficients in which a coefficient for the region including the predefined middle-brightness region and the skin-colored hue region and a coefficient for the region excluding the predefined middle-brightness region; have different signs from each other; and the third index using coefficients having different values according to distance from the edge, and the image processing condition determining step determines the image processing condition based on the first to third indexes calculated in the index calculating step.
   Item 20

According to the image processing method of item 19, the index calculating step calculates a fourth index and a fifth index by multiplying the first to third indexes by coefficients predefined based on photographed scene respectively and combining products of the first to third indexes and the coefficients, and the image processing condition determining step determines the image processing condition based on the fourth index and the fifth index calculated in the index calculating step.

Item 21

The image processing method of item 19 or 20, further includes: a histogram generating step of generating a two dimensional histogram by calculating accumulated numbers of pixels of the set of photographed image data for respective combinations of distance from an frame edge of the set of photographed image data and brightness, wherein the occupation ratio calculating step calculates the occupation ratios based on the two dimensional histogram.

Item 22

The image processing method of item 19 or 20 further includes: a histogram generating step of generating a two dimensional histogram by calculating accumulated numbers of pixels of the set of photographed image data for respective combinations of predefined hue and brightness, wherein the occupation ratio calculating step calculates the occupation ratios based on the two dimensional histogram.

Item 23

According to the image processing method of any one of items 19 to 22, the region excluding the hue region of the region including the predefined high-brightness region and the skin-colored hue region whose coefficient has a different sign from the coefficient of the region including the predefined high-brightness region and a skin-colored hue region has a brightness region which is the predefined high-brightness region.

Item 24

According to the image processing method of any one of items 19 to 22, the region excluding the predefined middle-brightness region whose coefficient has a different sign from the coefficient of the region including the predefined middle-brightness region and the skin-colored hue region has a hue region which is within the skin-colored hue region.

Item 25

According to the image processing method of any one of items 19 to 23, the region including the predefined high-brightness region and the skin-colored hue region includes a region whose brightness value in HSV color system is in a range of 170 to 224.

Item 26

According to the image processing method of any one of items 19 to 22 and 24, the region including the predefined middle-brightness region includes a region whose brightness value in HSV color system is in a range of 85 to 169.

Item 27

According to the image processing method of any one of items 19 to 23 and 25, the region excluding the predefined high-brightness region and the skin-colored hue region has a hue region including at least one of a blue hue region and a green hue region.

Item 28

According to the image processing method of any one of items 19 to 22, 24 and 26, the region excluding the predefined middle-brightness region is a shadow region.

Item 29

According to the image processing method of item 27, a brightness value in HSV color system of the blue hue region is in a range of 161 to 250 and a brightness value in HSV color system of the green hue region is in a range of 40 to 160.

Item 30

According to the image processing method of item 28, a brightness value in HSV color system of the shadow region is in a range of 26 to 84.

Item 31

According to the image processing method of any one of items 19 to 30, a hue value in HSV color system of the skin-colored hue region is in a range of 0 to 39 and 330 to 359.

Item 32

According to the image processing method of any one of items 19 to 31, the skin colored hue region is divided into two regions by a predefined conditional expression based on brightness and saturation.

Item 33

According to the image processing method of any one of items 1 to 32, the image processing condition determining step determines the image processing condition for applying a gradation converting processing to the set of photographed image data.

Item 34

According to the image processing method of any one of items 1 to 33, the coefficients predefined based on photographing conditions are a discriminal coefficients calculated by a discriminant analysis method.

Item 35

According to the image processing method of item 34, the coefficients predefined based on photographing conditions are values of discriminal coefficients regulated such that a discriminal function satisfies a predefined condition for each of a plurality of sample images corresponding to the photographing conditions.

Item 36

An image processing apparatus for processing a set of image data corresponding to one frame of image, includes: an occupation ratio calculating section for dividing the set of photographed image data into a plurality of regions based on at least one combination of a first combination of predefined brightness and hue; and a second combination of distance from a frame edge of the photographed image and brightness; and
calculating occupation ratios which represent an occupation ratio of each of the plurality of regions in the whole of the set of photographed image data;
an index calculating section for calculating an index determining a type of photographed scene by multiplying the occupation ratios calculated in the occupation ratio calculation section by coefficients predefined based on photographing conditions for the respective plurality of regions;
an image processing condition determining section for determining an image processing condition for the set of photographed image data based on the index calculated in the index calculating section.
   Item 37

The image processing apparatus of item 36, the occupation ratio calculating section divides the set of photographed image data into a plurality of regions based on a combination of predefined brightness and hue and calculates occupation ratios which represent an occupation ratio of each of the plurality of regions in a whole of the set of photographed image data and the index calculating section calculates the index based on at least one of: coefficients in which a coefficient for a region including a predefined high-brightness region and a skin-colored hue region and a coefficient for a region excluding a hue region of the region including the predefined high-brightness region and the skin-colored hue region have different signs from each other; and coefficients in which a coefficient for a region including a predefined middle-brightness region and the skin-colored hue region and a coefficient for a region excluding the predefined middle-brightness region; have different signs from each other.

Item 38

According to the image processing apparatus of item 37,
the index calculating section uses the coefficients in which the coefficient for the region including the predefined high-brightness region and the skin-colored hue region and the coefficient for the region excluding the hue region of the region including the predefined high-brightness region and the skin-colored hue region have different signs from each other.
   Item 39

According to the image processing apparatus of item 37, the index calculating section uses the coefficients in which
the coefficient for the region including the predefined middle-brightness region and the skin-colored hue region and the coefficient for the region excluding the predefined middle-brightness region; have different signs from each other.
   Item 40

According to the image processing apparatus of item 37, the index calculating section calculates a first index using coefficients in which the coefficient for the region including the predefined high-brightness region and the skin-colored hue region and the coefficient for the region excluding a hue region of the region including the predefined high-brightness region and the skin-colored hue region have different signs from each other, and calculates a second index using coefficients in which the coefficient for the region including the predefined middle-brightness region and the skin-colored hue region and the coefficient for the region excluding the predefined middle-brightness region have different signs from each other, and the image processing condition determining section determines the image processing condition based on the first index and the second index calculated in the index calculating section.

Item 41

The image processing apparatus of any one of items 37 to 40, further includes: a histogram generating section for generating a two dimensional histogram by calculating accumulated numbers of pixels of the set of photographed image data for respective combinations of predefined hue and brightness, wherein the occupation ratio calculating section calculates the occupation ratios based on the two dimensional histogram.

Item 42

According to the image processing apparatus of any one of items 37, 38, 40 and 41, the region excluding the hue region of the region including the predefined high-brightness region and the skin-colored hue region whose coefficient has a different sign from the coefficient of the region including the predefined high-brightness region and a skin-colored hue region has a brightness region which is the predefined high-brightness region.

Item 43

According to the image processing apparatus of any one of items 37, 39, 40 and 41, the region excluding the predefined middle-brightness region whose coefficient has a different sign from the coefficient of the region including the predefined middle-brightness region and the skin-colored hue region has a hue region which is within the skin-colored hue region.

Item 44

According to the image processing apparatus of any one of items 37, 38, 40 to 42, the region including the predefined high-brightness region and the skin-colored hue region includes a region whose brightness value in HSV color system is in a range of 170 to 224.

Item 45

According to the image processing apparatus of any one of items 37, 39 to 41, and 43, the region including the predefined middle-brightness region includes a region whose brightness value in HSV color system is in a range of 85 to 169.

Item 46

According to the image processing apparatus of any one of items 37, 39, 40 to 42 and 44, the region excluding the predefined high-brightness region and the skin-colored hue region has a hue region including at least one of a blue hue region and a green hue region.

Item 47

According to the image processing apparatus of any one of item 37, 39 to 41, 43 and 45,
the region excluding the predefined middle-brightness region is a shadow region.
   Item 48

According to the image processing apparatus of item 46,
a brightness value in HSV color system of the blue hue region is in a range of 161 to 250 and a brightness value in HSV color system of the green hue region is in a range of 40 to 160.
   Item 49

According to the image processing apparatus of item 47, a brightness value in HSV color system of the shadow region is in a range of 26 to 84.

Item 50

According to the image processing apparatus of any one of items 37 to 49, a hue value in HSV color system of the skin-colored hue region is in a range of 0 to 39 and 330 to 359.

Item 51

According to the image processing apparatus of any one of items 37 to 50, the skin colored hue region is divided into two regions by a predefined conditional expression based on brightness and saturation.

Item 52

According to the image processing apparatus of item 36,
the occupation ratio calculating section divides a set of photographed image data into a plurality of regions based on a combination of distance from an frame edge of the set of photographed image data and brightness and calculates an occupation ratios which represent a occupation ratio of each of the plurality of regions in a whole of the set of photographed image data and the image processing condition determining section determines the index based on coefficients having different values according to distance from the frame edge.
   Item 53

According to the image processing apparatus of item 52, further includes: a histogram generating section for generating a two dimensional histogram by calculating accumulated numbers of pixels of the set of photographed image data for respective combinations of predefined hue and brightness, wherein the occupation ratio calculating section calculates the occupation ratios based on the two dimensional histogram.

Item 54

According to the image processing apparatus of item 36, the occupation ratio calculating section divides the set of photographed image data into a plurality of regions based on a combination of predefined brightness and hue, calculates first occupation ratios which represent an occupation ratio of each of the plurality of regions in a whole of the set of photographed image data, divides the set of photographed image data into a plurality of regions based on a combination of distance from a frame edge of the set of photographed image data and brightness and calculates second occupation ratios which represent an occupation ratio of each of the plurality of regions in a whole of the set of photographed image data,
the index calculating section calculates the index determining a type of photographed scene by multiplying each of the first and second occupation ratios calculated in the occupation ratio calculation section by each of coefficients predefined based on photographing conditions,
the index calculating section further calculates: a first index using coefficients in which the coefficient for the region including the predefined high-brightness region and the skin-colored hue region and the coefficient for the region excluding a hue region of the region including the predefined high-brightness region and the skin-colored hue region have different signs from each other; a second index using coefficients in which coefficients in which a coefficient for the region including the predefined middle-brightness region and the skin-colored hue region and a coefficient for the region excluding the predefined middle-brightness region; have different signs from each other; and the third index using coefficients having different values according to distance from the edge, and the image processing condition determining section determines the image processing condition based on the first to third indexes calculated in the index calculating section.
   Item 55

According to the image processing apparatus of item 54,
the index calculating section calculates a fourth index and a fifth index by multiplying the first to third indexes by coefficients predefined based on photographed scene respectively and combining products of the first to third indexes and the coefficients, and the image processing condition determining section determines the image processing condition based on the fourth index and the fifth index calculated in the index calculating section.
   Item 56

The image processing apparatus of item 54 or 55, further includes: a histogram generating section for generating a two dimensional histogram by calculating accumulated numbers of pixels of the set of photographed image data for respective combinations of distance from an frame edge of the set of photographed image data and brightness, wherein the occupation ratio calculating section calculates the occupation ratios based on the two dimensional histogram.

Item 57

The image processing apparatus of item 54 or 55 further includes: a histogram generating section for generating a two dimensional histogram by calculating accumulated numbers of pixels of the set of photographed image data for each combinations of predefined hue and brightness, wherein the occupation ratio calculating section calculates the occupation ratios based on the two dimensional histogram.

Item 58

According to the image processing apparatus of any one of items 54 to 57, the region excluding the hue region of the region including the predefined high-brightness region and the skin-colored hue region whose coefficient has a different sign from the coefficient of the region including the predefined high-brightness region and a skin-colored hue region has a brightness region which is the predefined high-brightness region.

Item 59

According to the image processing apparatus of any one of items 54 to 57, the region excluding the predefined middle-brightness region whose coefficient has a different sign from the coefficient of the region including the predefined middle-brightness region and the skin-colored hue region has a hue region which is within the skin-colored hue region.

Item 60

According to the image processing apparatus of any one of items 54 to 58, the region including the predefined high-brightness region and the skin-colored hue region includes a region whose brightness value in HSV color system is in a range of 170 to 224.

Item 61

According to the image processing apparatus of any one of items 54 to 57 and 59, the region including the predefined middle-brightness region includes a region whose brightness value in HSV color system is in a range of 85 to 169.

Item 62

According to the image processing apparatus of any one of items 54 to 58 and 60, the region excluding the predefined high-brightness region and the skin-colored hue region has a hue region including at least one of a blue hue region and a green hue region.

Item 63

According to the image processing apparatus of any one of items 54 to 57, 59 and 61, the region excluding the predefined middle-brightness region is a shadow region.

Item 64

According to the image processing apparatus of item 62,
a brightness value in HSV color system of the blue hue region is in a range of 161 to 250 and a brightness value in HSV color system of the green hue region is in a range of 40 to 160.
   Item 65

According to the image processing apparatus of item 63,
wherein a brightness value in HSV color system of the shadow region is in a range of 26 to 84.
   Item 66

According to the image processing apparatus of any one of items 54 to 65,
a hue value in HSV color system of the skin-colored hue region is in a range of 0 to 39 and 330 to 359.
   Item 67

According to the image processing apparatus of any one of items 54 to 66, the skin colored hue region is divided into two regions by a predefined conditional expression based on brightness and saturation.

Item 68

According to the image processing apparatus of any one of items 36 to 67, the image processing condition determining section determines the image processing condition for applying a gradation converting processing to the set of photographed image data.

Item 69

According to the image processing apparatus of any one of items 36 to 68, the coefficients predefined based on photographing conditions are a discriminal coefficients calculated by a discriminant analysis apparatus.

Item 70

According to the image processing apparatus of item 69,
the coefficients predefined based on photographing conditions are values of discriminal coefficients regulated such that a discriminal function satisfies a predefined condition for each of a plurality of sample images corresponding to the photographing conditions.
   Item 71

An image recording apparatus for processing a set of image data corresponding to one frame of image, includes: an occupation ratio calculating section for dividing the set of photographed image data into a plurality of regions based on at least one combination of a first combination of predefined brightness and hue; and a second combination of distance from a frame edge of the photographed image and brightness; and
calculating occupation ratios which represent an occupation ratio of each of the plurality of regions in the whole of the set of photographed image data;
an index calculating section for calculating an index determining a type of photographed scene by multiplying the occupation ratios calculated in the occupation ratio calculation section by coefficients predefined based on photographing conditions for the respective plurality of regions;
an image processing condition determining section for determining an image processing condition for the set of set of photographed image data based on the index calculated in the index calculating section;
an image processing section for applying image processing to the set of set of photographed image data based on the image processing condition determined in the image processing condition determining section;
an image data generating section for generating an image data applied the image processing in the image processing section on an output medium.
   Item 72

According to the image recording apparatus of item 71,
the occupation ratio calculating section divides a set of photographed image data into a plurality of regions based on a combination of predefined brightness and hue and calculates an occupation ratio which represents an occupation ratio of each of the plurality of regions in a whole of the set of photographed image data and the index calculating section determines the index based on at least one of: coefficients in which a coefficient for the region including the predefined high-brightness region and a skin-colored hue region and a coefficient for a region excluding a hue region of the predefined high-brightness region and the skin-colored hue region have different signs from each other; and coefficients in which a coefficient for the region including the predefined middle-brightness region and the skin-colored hue region and a coefficient for the region excluding a brightness region of the predefined middle-brightness region;
have different signs from each other.
   Item 73

According to the image recording apparatus of item 72, wherein the index calculating section uses the coefficients in which the coefficient for the region including the predefined high-brightness region and a skin-colored hue region and the coefficient for a region excluding a hue region of the region including the predefined high-brightness region and the skin-colored hue region have different signs from each other.

Item 74

According to the image recording apparatus of item 72,
the index calculating section uses the coefficients in which the coefficient for the region including the predefined middle-brightness region and the skin-colored hue region and
the coefficient for the region excluding a brightness region of the predefined middle-brightness region; have different signs from each other.
   Item 75

According to the image recording apparatus of item 72,
the index calculating section calculates a first index using coefficients in which the coefficient for the region including the predefined high-brightness region and the skin-colored hue region and the coefficient for the region excluding a hue region of the region including the predefined high-brightness region and the skin-colored hue region have a different sign from each other, and calculates a second index using coefficients in which the coefficient for the region including the predefined middle-brightness region and the skin-colored hue region and the coefficient for the region excluding a brightness region of the predefined middle-brightness region have a different sign from each other, and the image processing condition determining section determines the image processing condition based on the first index and the second index calculated in the index calculating section.
   Item 76

The image recording apparatus of any one of items 72 to 75, further includes: a histogram generating a two dimensional histogram by calculating accumulated numbers of pixels of the set of photographed image data for respective combinations of predefined hue and brightness, wherein the occupation ratio calculating section calculates the occupation ratios based on the two dimensional histogram.

Item 77

According to the image recording apparatus of any one of items 72, 73, 75 and 76, the region excluding the hue region of the region including the predefined high-brightness region and the skin-colored hue region whose coefficient has a different sign from the coefficient of the region including the predefined high-brightness region and a skin-colored hue region has a brightness region which is the predefined high-brightness region.

Item 78

According to the image recording apparatus of any one of items 72, 74, 75 and 76, the region excluding the predefined middle-brightness region whose coefficient has a different sign from the coefficient of the region including the predefined middle-brightness region and the skin-colored hue region has a hue region which is within the skin-colored hue region.

Item 79

According to the image recording apparatus of any one of items 72, 73, 75 to 77,
the region including the predefined high-brightness region and the skin-colored hue region includes a region whose brightness value in HSV color system is in a range of 170 to 224.
   Item 80

According to the image recording apparatus of any one of items 72, 74 to 76 and 78,
wherein the region including the predefined middle-brightness region includes a region whose brightness value in HSV color system is in a range of 85 to 169.
   Item 81

According to the image recording apparatus of any one of items 72, 73, 75 to 77 and 79,
the region excluding the predefined high-brightness region and the skin-colored hue region has a hue region including at least one of a blue hue region and a green hue region.
   Item 82

According to the image recording apparatus of any one of items 72, 74 to 76, 78, and 80, the region excluding the predefined middle-brightness region is a shadow region.

Item 83

According to the image recording apparatus of item 81,
a brightness value in HSV color system of the blue hue region is in a range of 161 to 250 and a brightness value in HSV color system of the green hue region is in a range of 40 to 160.
   Item 84

According to the image recording apparatus of item 82,
a brightness value in HSV color system of the shadow region is in a range of 26 to 84.
   Item 85

According to the image recording apparatus of any one of items 72 to 84, a hue value in HSV color system of the skin-colored hue region is in a range of 0 to 39 and 330 to 359.

Item 86

According to the image recording apparatus of any one of item 72 to 85, the skin colored hue region is divided into two regions by a predefined conditional expression based on brightness and saturation.

Item 87

According to the image recording apparatus of item 71,
the occupation ratio calculating section divides a set of photographed image data into a plurality of regions based on a combination of distance from an frame edge of the set of photographed image data and brightness and
   calculates an occupation ratios which represent a occupation ratio of each of the plurality of regions in a whole of the set of photographed image data and the image processing condition determining section determines the index based on coefficients having different values according to distance from the frame edge.
      Item 88

The image recording apparatus of item 87, further includes: a histogram generating section of generating a two dimensional histogram by calculating accumulated numbers of pixels of the set of photographed image data for each combinations of predefined hue and brightness, wherein the occupation ratio calculating section calculates the occupation ratios based on the two dimensional histogram.

Item 89

According to the image recording apparatus of item 71,
the occupation ratio calculating section divides the set of photographed image data into a plurality of regions based on a combination of predefined brightness and hue, calculates first occupation ratios which represent an occupation ratio of each of the plurality of regions in a whole of the set of photographed image data, divides the set of photographed image data into a plurality of regions based on a combination of distance from a frame edge of the set of photographed image data and brightness and calculates second occupation ratios which represent an occupation ratio of each of the plurality of regions in a whole of the set of photographed image data,
the index calculating section calculates the index determining a type of photographed scene by multiplying each of the first and second occupation ratios calculated in the occupation ratio calculation section by each of coefficients predefined based on photographing conditions,
the index calculating section further calculates: a first index using coefficients in which the coefficient for the region including the predefined high-brightness region and the skin-colored hue region and the coefficient for the region excluding a hue region of the region including the predefined high-brightness region and the skin-colored hue region have different signs from each other; a second index using coefficients in which coefficients in which a coefficient for the region including the predefined middle-brightness region and the skin-colored hue region and a coefficient for the region excluding the predefined middle-brightness region; have different signs from each other; and the third index using coefficients having different values according to distance from the edge, and
the image processing condition determining section determines the image processing condition based on the first to third indexes calculated in the index calculating section.
   Item 90

According to the image recording apparatus of item 89,
the index calculating section calculates a fourth index and a fifth index by multiplying each of the first to third indexes is multiplied by coefficients predefined based on photographed scene and combining products of the first to third indexes and the coefficients, and the image processing condition determining section determines the image processing condition based on the fourth index and the fifth index calculated in the index calculating section.
   Item 91

The image recording apparatus of item 89 or 90, further includes: a histogram generating section of generating a two dimensional histogram by calculating accumulated numbers of pixels of the set of photographed image data for respective combinations of distance from an frame edge of the set of photographed image data and brightness, wherein the occupation ratio calculating section calculates the occupation ratios based on the two dimensional histogram.

Item 92

The image recording apparatus of item 89 or 90 further includes: a histogram generating section of generating a two dimensional histogram by calculating accumulated numbers of pixels of the set of photographed image data for respective combinations of predefined hue and brightness, wherein the occupation ratio calculating section calculates the occupation ratios based on the two dimensional histogram.

Item 93

According to the image recording apparatus of any one of items 89 to 92, the region excluding the hue region of the region including the predefined high-brightness region and the skin-colored hue region whose coefficient has a different sign from the coefficient of the region including the predefined high-brightness region and a skin-colored hue region has a brightness region which is the predefined high-brightness region.

Item 94

According to the image recording apparatus of any one of items 89 to 92, the region excluding the predefined middle-brightness region whose coefficient has a different sign from the coefficient of the region including the predefined middle-brightness region and the skin-colored hue region has a hue region which is within the skin-colored hue region.

Item 95

According to the image recording apparatus of any one of items 89 to 93,
wherein the region including the predefined high-brightness region and the skin-colored hue region includes a region whose brightness value in HSV color system is in a range of 170 to 224.
   Item 96

According to the image recording apparatus of any one of items 89 to 92 and 94,
wherein the region including the predefined middle-brightness region includes a region whose brightness value in HSV color system is in a range of 85 to 169.
   Item 97

According to the image recording apparatus of any one of items 89 to 93 and 95,
the region excluding the predefined high-brightness region and the skin-colored hue region has a hue region including at least one of a blue hue region and a green hue region.
   Item 98

According to the image recording apparatus of any one of items 89 to 92, 94 and 96, the region excluding the predefined middle-brightness region is a shadow region.

Item 99

According to the image recording apparatus of item 97,
a brightness value in HSV color system of the blue hue region is in a range of 161 to 250 and a brightness value in HSV color system of the green hue region is in a range of 40 to 160.
   Item 100

According to the image recording apparatus of item 98,
a brightness value in HSV color system of the shadow region is in a range of 26 to 84.
   Item 101

According to the image recording apparatus of any one of items 89 to 100,
a hue value in HSV color system of the skin-colored hue region is in a range of 0 to 39 and 330 to 359.
   Item 102

According to the image recording apparatus of any one of item 89 to 101,
the skin colored hue region is divided into two regions by a predefined conditional expression based on brightness and saturation.
   Item 103

According to the image recording apparatus of any one of items 71 to 102,
the image processing condition determining section determines the image processing condition for applying a gradation converting processing to the set of photographed image data.
   Item 104

According to the image recording apparatus of any one of items 71 to 103,
the coefficients predefined based on photographing conditions are a discriminal coefficients calculated by a discriminant analysis apparatus.
   Item 105

According to the image recording apparatus of item 104,
the coefficients predefined based on photographing conditions are values of discriminal coefficients regulated such that a discriminal function satisfies a predefined condition for each of a plurality of sample images corresponding to the photographing conditions.
   Item 106

An image processing program of processing a set of image data corresponding to one frame of image, includes the steps of: an occupation ratio calculating step of dividing the set of photographed image data into a plurality of regions based on at least one combination of a first combination of predefined brightness and hue; and a second combination of distance from a frame edge of the photographed image and brightness; and calculating occupation ratios which represent an occupation ratio of each of the plurality of regions in the whole of the set of photographed image data;
an index calculating step of calculating an index determining a type of photographed scene by multiplying the occupation ratios calculated in the occupation ratio calculation step by coefficients predefined based on photographing conditions for the respective plurality of regions;
an image processing condition determining step of determining an image processing condition for the set of photographed image data based on the index calculated in the index calculating step.
   Item 107

According to the image processing program of item 106,
the occupation ratio calculating step divides the set of photographed image data into a plurality of regions based on a combination of predefined brightness and hue and calculates occupation ratios which represent an occupation ratio of each of the plurality of regions in a whole of the set of photographed image data and
the index calculating step calculates the index based on at least one of: coefficients in which a coefficient for a region including a predefined high-brightness region and a skin-colored hue region and a coefficient for a region excluding a hue region of the region including the predefined high-brightness region and the skin-colored hue region have different signs from each other; and coefficients in which a coefficient for a region including a predefined middle-brightness region and the skin-colored hue region and a coefficient for a region excluding the predefined middle-brightness region; have different signs from each other.
   Item 108

According to the image processing program of item 107,
the index calculating step uses the coefficients in which
the coefficient for the region including the predefined high-brightness region and the skin-colored hue region and the coefficient for the region excluding the hue region of the region including the predefined high-brightness region and the skin-colored hue region have different signs from each other.
   Item 109

According to the image processing program of item 107, the index calculating step uses the coefficients in which the coefficient for the region including the predefined middle-brightness region and the skin-colored hue region and the coefficient for the region excluding the predefined middle-brightness region; have different signs from each other.

Item 110

According to the image processing program of item 107, the index calculating step calculates a first index using coefficients in which the coefficient for the region including the predefined high-brightness region and the skin-colored hue region and the coefficient for the region excluding a hue region of the region including the predefined high-brightness region and the skin-colored hue region have different signs from each other, and calculates a second index using coefficients in which the coefficient for the region including the predefined middle-brightness region and the skin-colored hue region and the coefficient for the region excluding the predefined middle-brightness region have different signs from each other, and the image processing condition determining step determines the image processing condition based on the first index and the second index calculated in the index calculating step.

Item 111

The image processing program of any one of items 107 to 110, further includes: a histogram generating step of generating a two dimensional histogram by calculating accumulated numbers of pixels of the set of photographed image data for respective combinations of predefined hue and brightness, wherein the occupation ratio calculating step calculates the occupation ratios based on the two dimensional histogram.

Item 112

According to the image processing program of any one of items 107, 108, 110 and 111, the region excluding the hue region of the region including the predefined high-brightness region and the skin-colored hue region whose coefficient has a different sign from the coefficient of the region including the predefined high-brightness region and a skin-colored hue region has a brightness region which is the predefined high-brightness region.

Item 113

According to the e image processing program of any one of items 107, 109, 110 and 111, the region excluding the predefined middle-brightness region whose coefficient has a different sign from the coefficient of the region including the predefined middle-brightness region and the skin-colored hue region has a hue region which is within the skin-colored hue region.

Item 114

According to the e image processing program of any one of items 107, 108, 110 to 112,
the region including the predefined high-brightness region and the skin-colored hue region includes a region whose brightness value in HSV color system is in a range of 170 to 224.
   Item 115

According to the image processing program of any one of items 107, 109 to 111 and 113,
the region including the predefined middle-brightness region includes a region whose brightness value in HSV color system is in a range of 85 to 169.
   Item 116

According to the image processing program of any one of items 107, 109, 110 to 112 and 114,
the region excluding the predefined high-brightness region and the skin-colored hue region has a hue region including at least one of a blue hue region and a green hue region.
   Item 117

According to the image processing program of any one of items 107, 109 to 111, 113 and 115, the region excluding the predefined middle-brightness region is a shadow region.

Item 118

According to the image processing program of item 116,
a brightness value in HSV color system of the blue hue region is in a range of 161 to 250 and a brightness value in HSV color system of the green hue region is in a range of 40 to 160.
   Item 119

According to the image processing program of item 117,
a brightness value in HSV color system of the shadow region is in a range of 26 to 84.
   Item 120

According to the image processing program of any one of items 107 to 119,
a hue value in HSV color system of the skin-colored hue region is in a range of 0 to 39 and 330 to 359.
   Item 121

According to the image processing program of any one of items 107 to 120,
the skin colored hue region is divided into two regions by a predefined conditional expression based on brightness and saturation.
   Item 122

According to the image processing program of item 107, the occupation ratio calculating step divides a set of photographed image data into a plurality of regions based on a combination of distance from an frame edge of the set of photographed image data and brightness and calculates an occupation ratios which represent a occupation ratio of each of the plurality of regions in a whole of the set of photographed image data and the index calculating step calculates the index based on coefficients having different values according to distance from the frame edge.

Item 123

The image processing program of item 122, further includes: a histogram generating step of generating a two dimensional histogram by calculating accumulated numbers of pixels of the set of photographed image data for respective combinations of predefined hue and brightness,
wherein the occupation ratio calculating step calculates the occupation ratios based on the two dimensional histogram.
   Item 124

According to the image processing program of item 106, the occupation ratio calculating step divides the set of photographed image data into a plurality of regions based on a combination of predefined brightness and hue, calculates first occupation ratios which represent an occupation ratio of each of the plurality of regions in a whole of the set of photographed image data, divides the set of photographed image data into a plurality of regions based on a combination of distance from a frame edge of the set of photographed image data and brightness and calculates second occupation ratios which represent an occupation ratio of each of the plurality of regions in a whole of the set of photographed image data,
the index calculating step calculates the index determining a type of photographed scene by multiplying each of the first and second occupation ratios calculated in the occupation ratio calculation step by each of coefficients predefined based on photographing conditions,
the index calculating step further calculates:
   a first index using coefficients in which the coefficient for the region including the predefined high-brightness region and the skin-colored hue region and the coefficient for the region excluding a hue region of the region including the predefined high-brightness region and the skin-colored hue region have different signs from each other; a second index using coefficients in which coefficients in which a coefficient for the region including the predefined middle-brightness region and the skin-colored hue region and a coefficient for the region excluding the predefined middle-brightness region; have different signs from each other; and the third index using coefficients having different values according to distance from the edge, and
the image processing condition determining step determines the image processing condition based on the first to third indexes calculated in the index calculating step.
   Item 125

According to the image processing program of item 124, the index calculating step calculates a fourth index and a fifth index by multiplying the first to third indexes by coefficients predefined based on photographed scene respectively and combining products of the first to third indexes and the coefficients, and
the image processing condition determining step determines the image processing condition based on the fourth index and the fifth index calculated in the index calculating step.
   Item 126

The image processing program of item 124 or 125, further includes: a histogram generating step of generating a two dimensional histogram by calculating accumulated numbers of pixels of the set of photographed image data for respective combinations of distance from an frame edge of the set of photographed image data and brightness, wherein the occupation ratio calculating step calculates the occupation ratios based on the two dimensional histogram.

Item 127

The image processing program of item 124 or 125 further includes: a histogram generating step of generating a two dimensional histogram by calculating accumulated numbers of pixels of the set of photographed image data for respective combinations of predefined hue and brightness, wherein the occupation ratio calculating step calculates the occupation ratios based on the two dimensional histogram.

Item 128

According to the image processing program of any one of items 124 to 127, the region excluding the hue region of the region including the predefined high-brightness region and the skin-colored hue region whose coefficient has a different sign from the coefficient of the region including the predefined high-brightness region and a skin-colored hue region has a brightness region which is the predefined high-brightness region.

Item 129

According to the image processing program of any one of items 124 to 127, the region excluding the predefined middle-brightness region whose coefficient has a different sign from the coefficient of the region including the predefined middle-brightness region and the skin-colored hue region has a hue region which is within the skin-colored hue region.

Item 130

According to the image processing program of any one of items 124 to 128,
the region including the predefined high-brightness region and the skin-colored hue region includes a region whose brightness value in HSV color system is in a range of 170 to 224.
   Item 131

According to the image processing program of any one of items 124 to 127 and 129,
the region including the predefined middle-brightness region includes a region whose brightness value in HSV color system is in a range of 85 to 169.
   Item 132

According to the image processing program of any one of items 124 to 128 and 130,
the region excluding the predefined high-brightness region and the skin-colored hue region has a hue region including at least one of a blue hue region and a green hue region.
   Item 133

According to the image processing program of any one of items 124 to 127, 129 and 131, the region excluding the predefined middle-brightness region is a shadow region.

Item 134

According to the image processing program of item 132,
a brightness value in HSV color system of the blue hue region is in a range of 161 to 250 and a brightness value in HSV color system of the green hue region is in a range of 40 to 160.
   Item 135

According to the image processing program of item 133,
a brightness value in HSV color system of the shadow region is in a range of 26 to 84.
   Item 136

According to the image processing program of any one of items 124 to 135,
a hue value in HSV color system of the skin-colored hue region is in a range of 0 to 39 and 330 to 359.
   Item 137

According to the image processing program of any one of items 124 to 136,
the skin colored hue region is divided into two regions by a predefined conditional expression based on brightness and saturation.
   Item 138

According to the image processing program of any one of items 106 to 137,
the image processing condition determining step determines the image processing condition for applying a gradation converting processing to the set of photographed image data.
   Item 139

According to the image processing program of any one of items 106 to 138,
the coefficients predefined based on photographing conditions are a discriminal coefficients calculated by a discriminant analysis program.
   Item 140

According to the image processing program of item 139,
the coefficients predefined based on photographing conditions are values of discriminal coefficients regulated such that a discriminal function satisfies a predefined condition for each of a plurality of sample images corresponding to the photographing conditions.

According to the present invention, it becomes possible to properly correct the brightness of the face region of an object of photographed image data where the object is human body by calculating an index that quantitatively represents the photographed scene (light source condition, (frontal light, backlight, or strobe-light)) and determining the image processing condition of the photographed image data based on the calculated index.

Particularly by calculating the index 1 that quantitatively represents the probability of strobe-light photography, that is, the brightness condition of the face region in case of strobe-light photography, high-brightness region of the face region can be corrected properly.

In addition, by calculating the index 2 that quantitatively represents the probability of back lighting photography, that is, the brightness condition of the face region in case of back lighting photography, low-brightness region of the face region can be corrected properly.

Furthermore, by calculating the index 3 that quantitatively represents the photographed scene from the composition and brightness distribution of the displayed photographed image data, brightness region of the face region can be properly corrected.

Particularly by using the index 3 deduced from compositional element of the photographed image data in addition to using the index 1 and index 2, discrimination accuracy of photographed scene can improve.

An embodiment of the present invention is described hereunder in detail, using figures.

To start with, the construction of the embodiment is described.

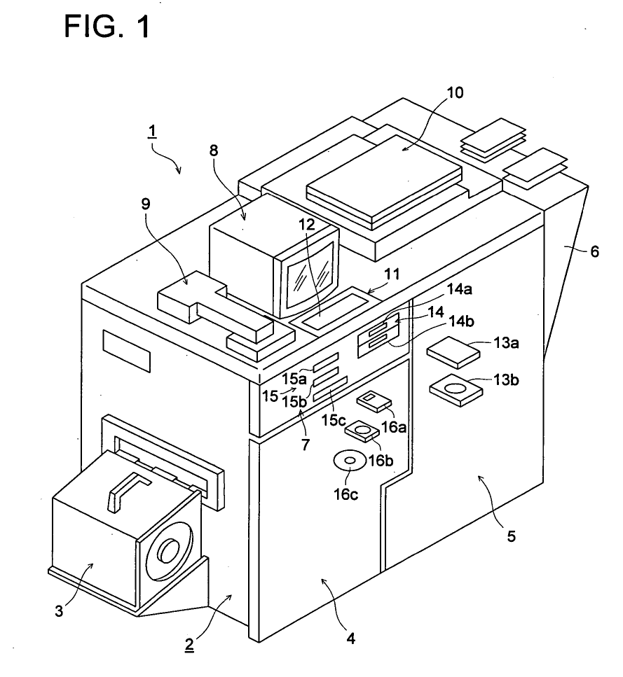

FIG. 1 is a perspective view showing the external construction of an image recording apparatus 1 according to the embodiment of the present invention. As shown in FIG. 1, the image recording apparatus 1 is equipped on one side of a case 2 with a magazine loader 3 for loading photosensitive material. There are provided an exposure processor 4 for exposing image on the photosensitive material and print generator 5 for developing and drying the exposed photosensitive material to generate print inside the case 2. On the other side of the case 2, there is provided a tray 6 for ejecting the print generated by the print generator 5.

On the top of the case 2, there are provided a CRT (cathode ray tube) 8 as a display unit, film scanner 9 for reading transparency, reflection copy input unit 10, and operation panel 11. The CRT 8 constitutes the display means for displaying the image of image data to be printed on a screen. The case 2 is further equipped with an image reader 14 that can read image data recorded in various types of digital recording media, and image writer 15 that can write (output) image signal into various types of digital recording media. There is provided a controller 7 inside the case 2 for central control of these devices.

The image reader 14 is equipped with a PC card adaptor 14a and floppy disk adaptor 14b, into which PC card 13a and floppy disk 13b can be inserted. A PC card 13a contains a memory in which, for example, multiple frame image data photographed by a digital camera are recorded. In a floppy disk 13b, for example, multiple frame image data photographed by a digital camera is recorded. Recording media include, for example, Multimedia card™, Memory Stick®, MD data, and CR-ROM in addition to PC card 13a and floppy disk 13b.

The image writer 15 is equipped with a floppy disk adaptor 15a, MO adaptor 15b, and optical disc adaptor 15c, into which FD 16a, MO 16b and optical disk 16c can be inserted, respectively. Optical disk 16c includes CD-R and DVD-R.

Although the operation panel 11, CRT 8, film scanner 9, reflection copy input unit 10 and image reader 14 are constructed all together with the case 2 in FIG. 1, any one of these can be installed separately.

The image recording apparatus 1 in FIG. 1 shows an example where image is exposed on a photosensitive material and then developed to generate a print, but the method of generating a print is not limited thereto but can be any other including ink jet method, electrophotographic method, thermal method, and sublimation method.

Construction of Major Portions of the Image Recording Apparatus 1:

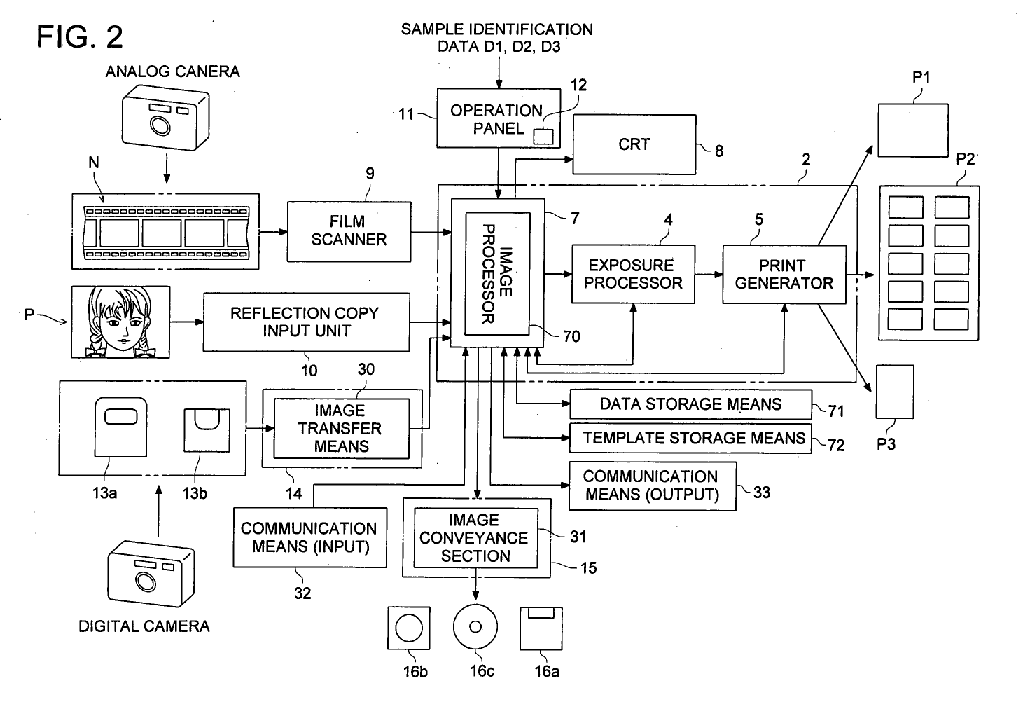

FIG. 2 shows the construction of major portions of the image recording apparatus 1. As shown in FIG. 2, the image recorder comprises the controller 7, exposure processor 4, print generator 5, film scanner 9, reflection copy input unit 10, image reader 14, communication means (input) 32, image writer 15, data storage means 71, template storage means 72, operation panel 11, CRT 8, and communication means (output) 33.

The controller 7, made of a micro computer, controls the operation of each portion constituting the image recording apparatus 1 with the joint aids of various control program stored in the storage device (not shown) such as ROM (read only memory) and the CPU (central processing unit).

The controller 7 contains an image processor (image processing section) 70, to which the image processing apparatus of the present invention applies, performs image processing for the image signal read from the film scanner 9 or reflection copy input unit 10, image signal read from the image reader 14, or image signal inputted from an external device via the communication means 32, based on the input signal (command data) from the operation panel 11, generates image data for exposure, and outputs it to the exposure processor 4. The image processor 70 outputs the data after performing necessary conversion of the processed image signal in accordance with the output mode. The image processor 70 outputs the data to the devices such as CRT 8, image writer 15, and communication means (output) 33.

The exposure processor 4 exposes image on photosensitive material and outputs the photosensitive material to the print generator 5. The print generator 5 develops and dries the exposed photosensitive material and generates prints P1, P2 and P3. Print P1 is a print of a size such as service size, high-vision size, or panorama size. Print P2 is a print of A4 size. Print P3 is a print of name-card size.

The exposure processor 4 and the print generator 5 are may be integrated and provided as an image data generating section.

The film scanner 9 reads frame image photographed by an analog camera and recorded on a developed negative film N or reversal film and obtains digital image signal of the frame image. The reflection copy input unit 10 reads image on a print P (photo print, picture, and other printed matter) with the aid of a flat bet scanner and obtains digital image signal.

The image reader 14 reads frame image data recorded on a PC card 13a or floppy disk 13b and transfers it to the controller 7. The image reader 14 is equipped with a PC card adaptor 14a and floppy disk adaptor 14b and the like as an image transfer means 30. The image reader 14 reads frame image data recorded on a PC card 13a inserted in the PC card adaptor 14a or on a floppy disk 13b inserted in the floppy disk adaptor 14b and transfers it to the controller 7. As the PC card adaptor 14a, a PC card reader or PC card slot is employed, for example.

The communication means (input) 32 receives image signal or print command signal representing the photographed image from other computer in the facility where the image recording apparatus 1 is installed or from a remote computer via the internet.

The image writer 15 is equipped with a floppy disk adaptor 15a, MO adaptor 15b and optical disk adaptor 15c as an image conveyance section 31. The image writer 15 writes the image signal generated according to the image processing method of the present invention into a floppy disk 16a inserted in the floppy disk adaptor 15a, MO 16b inserted in the MO adaptor 15b, or optical disk 16c inserted in the optical disk adaptor 15c based on the write signal inputted from the controller 7.

The data storage means 71 stores the image data and corresponding order data (information as to how many prints must be generated from which frame image, information on print size, etc.) and accumulates it one after another.

The template storage means 72 stores at least one template data used for setting a composite region together with a background image or illustrated image which is a sample image data corresponding to sample identification data D1, D2, D3. A specified template is selected out of multiple templates that have been prepared by operator and stored in the template storage means 72, frame image data is then composed from the selected template, and the sample image data selected based on a specified sample identification data D1, D2, D3 is combined with an image data and/or character data to order into a print conforming to a specified sample. This composition using the template is done by the well-known chromakey technique.

Although the unit is so constructed that the sample identification data D1, D2, D3 specifying a print sample is inputted from the operation panel 11, the sample identification data can be read with a reading means such as OCR because it is recorded on a print sample or order sheet. It can also be inputted from keyboard by operator.

Because a sample image data are recorded corresponding to the sample identification data D1 specifying a print sample, the sample identification data D1 specifying a print sample is inputted, a sample image data is selected based on the inputted sample identification data D1, and the selected sample image data and the image data and/or character data to order are combined so as to generate a print based on the specified sample, user can order prints by actually referring to various full-scale samples, enabling to meet diversified users' various requirements.

Also because the first sample identification data D2 specifying the first sample and the first sample image data are recorded, the second sample identification data D3 specifying the second sample and the second sample image data are recorded, and the sample image data selected based on the specified first and second ample identification data D2, D3 and the image data and/or character data to order are combined so as to generate a print based on the specified sample, more various images can be combined together, enabling to generate prints meeting further diversified users' various requirements.

The operation panel 11 is equipped with a data input means 12. The data input means 12 employs touch panel, for example, and pressing the data input means 12 is outputted as an input signal to the controller 7. The operation panel 11 may be constructed using, for example, keyboard and mouse. The CRT 8 displays image data according to the display control signal inputted from the controller 7.

The communication means (output) 33 sends out image signal, representing the photographed image that has undergone the image processing of the invention, and relevant order data to other computer in the facility where the image recording apparatus is installed or to a remote computer via the internet.

As shown in FIG. 2, the image recording apparatus 1 comprises an image input means for obtaining image data from various digital media image and image original through division-photometry, image processing means, image output means for displaying the processed image, outputting it as print and writing it into image recording media, and means for sending the image data and relevant order data to other computer in the facility via a telecommunication line or to a remote computer via the internet.

Internal Construction of the Image Processor 70:

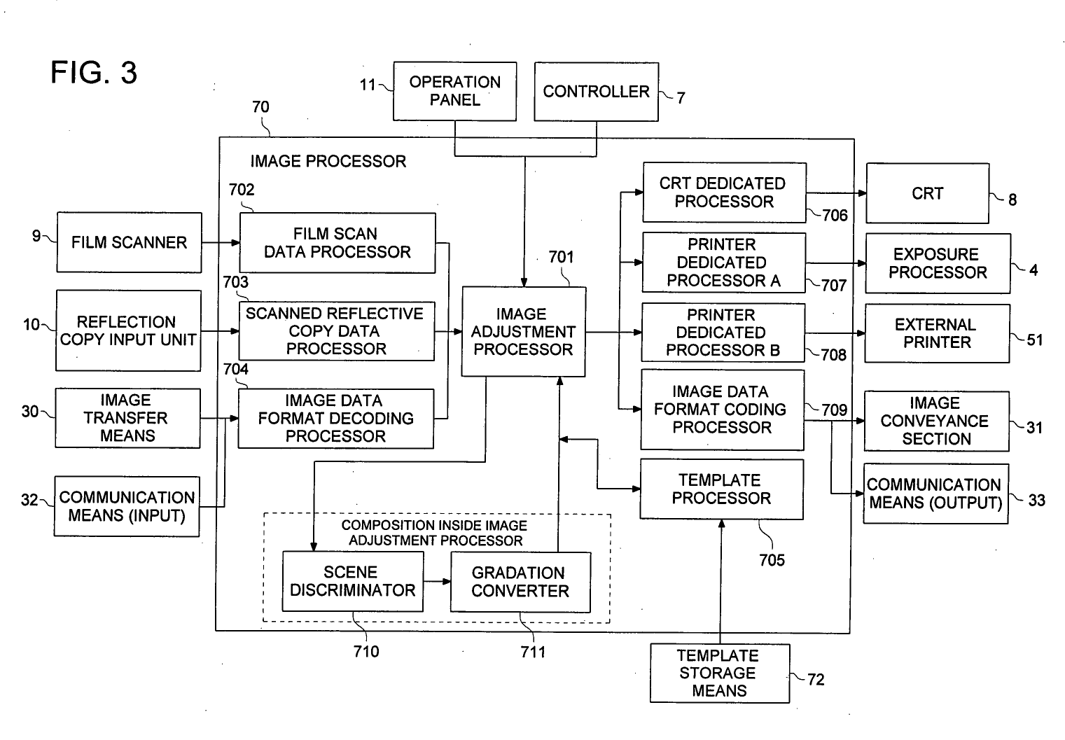

FIG. 3 shows the internal construction of the image processor 70. As shown in FIG. 3, the image processor 70 comprises an image adjustment processor 701, scanned film data processor 702, scanned reflection copy data processor 703, image data format decoding processor 704, template processor 705, CRT dedicated processor 706, printer dedicated processor A 707, printer dedicated processor B 708, and image data format coding processor 709.

The scanned film data processor 702 performs various processing including correction specific to the film scanner 9, negative-positive conversion (in case of negative copy), stain and scratch elimination, contrast adjustment, granular noise removal, and sharp enhancement for the image data inputted from the film scanner 9, and outputs the processed image data to the image adjustment processor 701. It additionally outputs film size, negative/positive type, data relating to the major object that has been optically or magnetically recorded on the film, data concerning the photographing condition (for example, data contained in APS), etc. to the image adjustment processor 701.

The scanned reflection copy data processor 703 performs various processing including correction specific to the reflection copy input unit 10, negative-positive conversion (in case of negative copy), stain and scratch elimination, contrast adjustment, noise removal, and sharp enhancement for the image data inputted from the reflection copy input unit 10, and outputs the processed image data to the image adjustment processor 701.

The image data format decoding processor 704 performs processing including restoration of compression sign and conversion of color data representation, as needed, for the image data inputted from the image transfer means 30 and/or communication means (input) 32 in accordance with the data format of the image data so as to convert it into the data format suitable for the computation in the image processor 70, and outputs it to the image adjustment processor 701. In addition, when the size of output image is specified by any of the operation panel 11, communication means (input) 32 and image transfer means 30, the image data format decoding processor 704 detects the specified information and outputs it to the image adjustment processor 701. The information on the size of the output image specified by the image transfer means 30 has been embedded in the header information or tag information of the image data the image transfer means 30 has obtained.

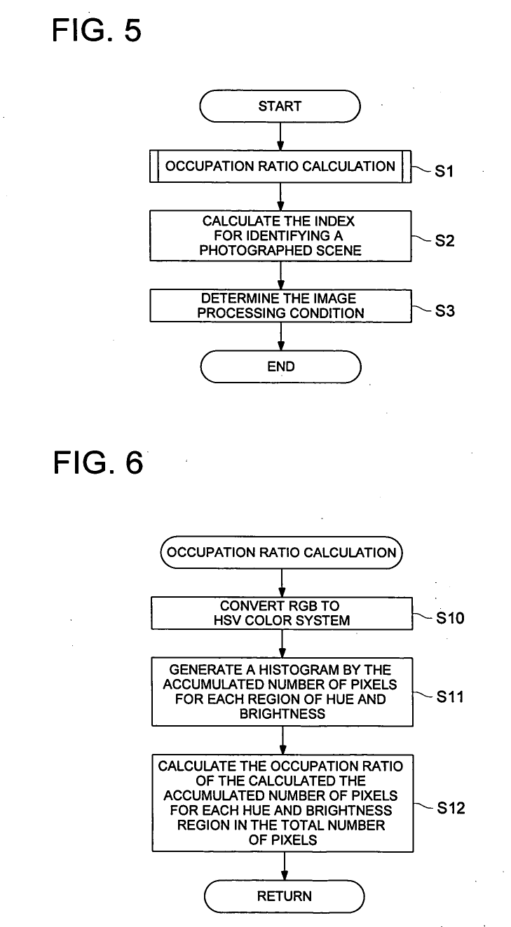

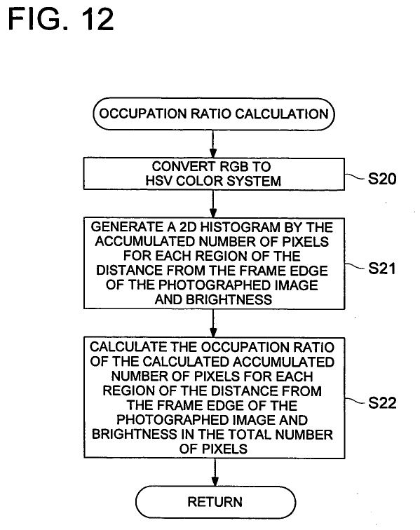

The image adjustment processor 701 performs processing as mentioned later (see FIG. 5, FIG. 6 and FIG. 12) for the image data received from the film scanner 9, reflection copy input unit 10, image transfer means 30, communication means (input) 32, and template processor 705 based on the instruction from the operation panel 11 or controller 7 and generates digital image data for forming image optimized for appreciation on an output medium, and then outputs it to the CRT dedicated processor 706, printer dedicated processor A 707, printer dedicated processor B 708, image data format coding processor 709, and data storage means 71.

In the optimization processing, if the image is to be displayed on a CRT display monitor conforming to the sRGB standard, the image is so processed that optimum colors can be reproduced within the color area of the sRGB standard. If the image is to be outputted on a silver halide photo paper, the image is so processed that optimum colors can be reproduced within the color area of silver halide photo paper. The processing includes not only the above color area compression but also gradation compression from 16-bit to 8-bit, decrease of the number of output pixels, and accordance with the output characteristic (LUT) of output device. Naturally, noise reduction, sharpening, gray balance adjustment, hue adjustment, and gradation compression such as dodging are also included.

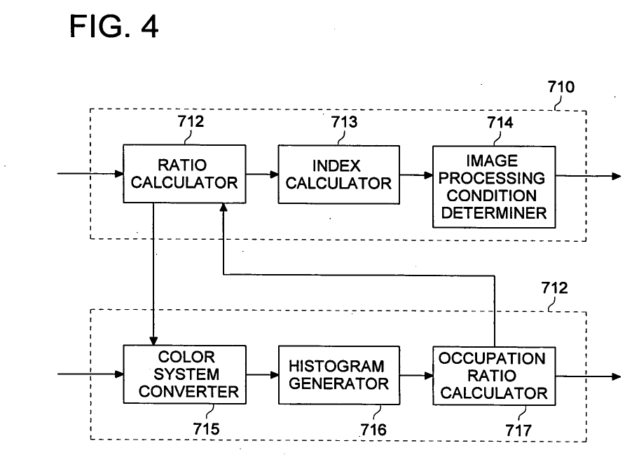

The image adjustment processor 701 comprises a scene discriminator 710 and gradation converter 711. FIG. 4 shows the internal construction of the scene discriminator 710. As shown in FIG. 4, the scene discriminator 710 comprises a ratio calculator 712, index calculator (index calculating section) 713 and image processing condition determiner (image processing condition determining section) 714. As shown in FIG. 4, the ratio calculator 712 comprises a color system converter 715, histogram generator (histogram generating section) 716 and occupation ratio calculator (occupation ratio calculating section) 717.

The color system converter 715 converts the RGB (Red, Green, Blue) value of photographed image data to the HSV color system. The HSV color system, devised on the basis of a color system proposed by Munsell, expresses image data in three elements, Hue, Saturation, and Value or Brightness.

In this embodiment, “brightness” means a commonly used term “brightness” unless otherwise specified. Although the “brightness” is defined as V (0 to 255) of the HSV color system in the description hereunder, a unit system representing the brightness in any other color system is applicable. It, however, is needless to say that various values such as coefficients mentioned in this embodiment must be re-calculated. In addition, the photographed image data in this embodiment is an image data where the major object is human body.

The histogram generator 716 divides the photographed image data (a set of image data corresponding to one frame of image) into regions based on a combination of specified hue and brightness, and generates a two-dimensional histogram by calculating accumulated number of pixels for each divided region. The histogram generator 716 also divides the photographed image data into specified regions based on a combination of the distance from the frame edge of the photographed image data screen and brightness, and generates a two-dimensional histogram by calculating accumulated number of pixels for each divided region. It is also permissible to generate a three-dimensional histogram by dividing the photographed image data into regions comprising a combination of the distance from the frame edge of the display of the photographed image data, brightness and hue and calculating accumulated number of pixels for each divided region. In the description hereunder, the process of generating two-dimensional histogram is employed.

The occupation ratio calculator 717 calculates the first occupation ratio (see Table 1) of the accumulated number of pixels calculated by the histogram generator 716 in the total number of pixels (whole photographed image data) for each divided region including a combination of the brightness and hue. The occupation ratio calculator 717 also calculates the second occupation ratio (see Table 4) of the accumulated number of pixels calculated by the histogram generator 716 in the total number of pixels (whole photographed image data) for each divided region including a combination of the distance from the frame edge of the photographed image data screen and brightness.

The index calculator 713 calculates index 1 for determining a type of photographed scene by multiplying the first occupation ratio calculated for each region by the occupation ratio calculator 717 by the first coefficient (see Table 2), which has been predefined corresponding to photographing condition, and summing up the products. The photographing condition means the light source condition for photographing an object such as frontal light, backlight or strobe-light condition. The index 1 represents characteristic specific to strobe-light photography such as indoor shot level, close-up shot level and face-color brightness and is used to separate an image that must be judged to have been photographed under “strobe-light condition” from other photographed scenes (light conditions).

In calculating the index 1, the index calculator 713 employs a coefficient having different sign for the region with the predefined high-brightness region and skin-colored hue region and for the hue region excluding the region with the high-brightness region and skin-colored region. The region with the predefined high-brightness region and skin-colored hue region includes the region having the brightness 170 to 224 in the HSV color system. The hue region excluding the region with the high-brightness region and skin-colored region includes at least either high-brightness region of the blue hue region (hue value 161 to 250) and green hue region (hue value 40 to 160).

The index calculator 713 calculates index 2 for determining a type of photographed scene by multiplying the first occupation ratio calculated for each region by the occupation ratio calculator 717 by the second coefficient (see Table 3), which has been predefined corresponding to photographing condition, and summing up the products. The index 2 represents composite characteristic specific to backlight photography such as outdoor shot level, sky-color brightness and face-color brightness and is used to separate an image that must be judged to have been photographed under “backlight condition” from other photographed scenes (light conditions).

In calculating the index 2, the index calculator 713 employs a coefficient having different sign for the region with skin-colored hue region (hue value 0 to 39, 330 to 359) and middle-brightness region and for the brightness region excluding the middle-brightness region. The region with the skin-colored region and middle-brightness region with the region having the brightness 85 to 169. The brightness region excluding the middle-brightness region includes, for example, the shadow region (brightness value 26 to 84).

Furthermore, the index calculator 713 calculates index 3 for determining a type of photographed scene by multiplying the second occupation ratio calculated for each region by the occupation ratio calculator 717 by the third coefficient (see Table 5), which has been predefined corresponding to photographing condition, and summing up the products. The index 3 represents the difference in the brightness between the center and outside of the photographed image data, indicating an image that must be judged to have been photographed under “backlight or strobe-light condition” quantitatively. In calculating the index 3, the index calculator 713 employs a coefficient of different value depending upon the distance from the frame edge of the photographed image data screen.

The index calculator 713 also calculates index 4 by multiplying the index 1 and index 3 each by a coefficient, which has been predefined corresponding to photographing condition, and combining the products. The index calculator 713 further calculates index 5 by multiplying the index 1, index 2 and index 3 each by a coefficient, which has been predefined corresponding to photographing condition, and combining the products. Concrete calculation of the indexes 1 to 5 by the index calculator 713 will be described in detail later in the course of describing the operation of this embodiment.

The image processing condition determiner 714 discriminates the photographed scene (light condition) based on the value of index 4 and index 5 calculated by the index calculator 713, and determines the image processing condition (gradation conversion condition) for the photographed image data based on the discrimination result, index 4 and index 5 calculated by the index calculator 713, and other parameters (such as average luminance of the photographed image data).

Concrete calculation of the indexes 1 to 5 by the index calculator 713, discrimination of the photographed scene (light condition) and determination of the image processing condition by the image processing condition determiner 714 will be described in detail later in the course of describing the operation of this embodiment.

In FIG. 3, the gradation converter 711 converts the gradation of photographed image data in accordance with the image processing condition (gradation conversion condition) determined by the image processing condition determiner 714.

The template processor 705 reads the specified image data (template) from the template storage means 72 based on the instruction from the image adjustment processor 701, combines the image data to be processed with the template, and outputs the template-processed image data to the image adjustment processor 701.

The CRT dedicated processor 706 performs necessary processing including change of number of pixels and color matching for the image data inputted from the image adjustment processor 701 and outputs display image data, combined with other information such as control data that needs to be displayed, to the CRT 8.

The printer dedicated processor A 707 performs necessary processing including correction, color matching and change of number of pixels and outputs the processed image data to the exposure processor 4.

If an external printer 51 such as a large-size ink jet printer can be connected with the image recording apparatus 1 of the present invention, there is provided the printer dedicated processor B 708 for each printer to be connected. The printer dedicated processor B 708 performs processing specific to the printer, including correction, color matching and change of number of pixels, and outputs the processed image data to the external printer 51.

The image data format coding processor 709 converts the image data inputted from the image adjustment processor 701 into a various general image format such as JPEG, TIFF or Exif as needed and outputs the processed image data to the image conveyance section 31 or communication means (output) 33.

Although each of the scanned film data processor 702, scanned reflection copy data processor 703, image data format decoding processor 704, image adjustment processor 701, CRT dedicated processor 706, printer dedicated processor A 707, printer dedicated processor B 708, and image data format coding processor 709 is shown as a section in FIG. 3, they are sectionalized simply for the ease of understanding the function of the image processor 70 and need not always be realized as physically independent device; they can, for example, be realized as separate software processing by a single CPU.

The operation of the embodiment is described hereunder.

To start with, scene discrimination by the scene discriminator 710 of the image adjustment processor 701 is described hereunder, using the flowchart in FIG. 5.

Occupation ratio calculation is performed in the ratio calculator 712, where the photographed image data is divided into specified image regions and the occupation ratio, representing the occupation ratio of each divided region in the whole photographed image data, is calculated (step S1). Detail of the occupation ratio calculation will be described later, using FIG. 6 and FIG. 12.

Next, based on the occupation ratio calculated by the ratio calculator 712 and coefficient which has been predefined corresponding to photographing condition, an index (index 1 to 5) for determining a type of photographed scene (indicating the light source condition quantitatively) is calculated (step S2). The index calculation in step S2 will be described in detail later.

Next, the photographed scene is discriminated based on the index calculated in step S2 and the image processing condition (gradation conversion condition) for the photographed image data is determined based on the discrimination result (step S3), and now the scene discrimination is complete. Determination of the image processing condition will be described in detail later.

Now, the occupation ratio calculation by the ratio calculator 712 is described in detail hereunder, using the flowchart in FIG. 6.

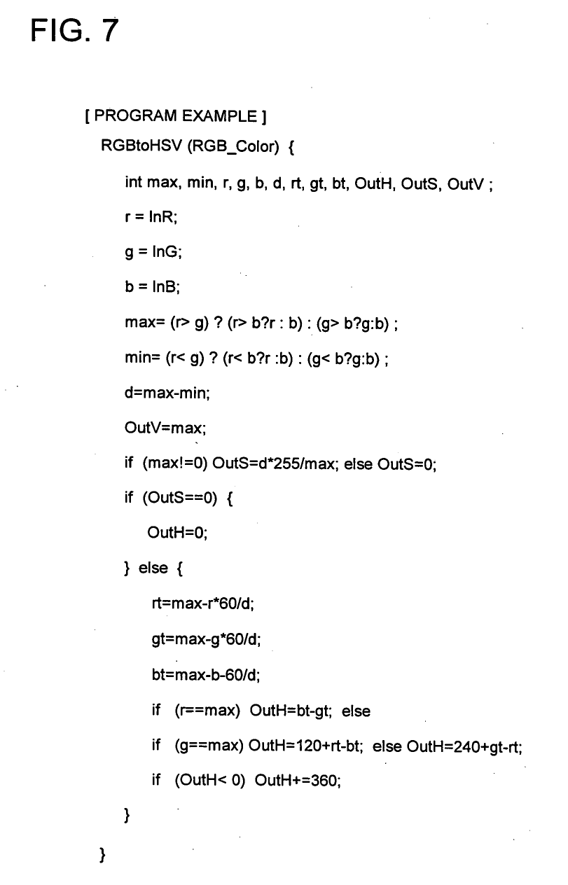

Firstly, the RGB value of the photographed image data is converted into the HSV color system (step S10). FIG. 7 shows an example conversion program (HSV conversion program), written by a program code (c language), for converting RGB into HSV color system and obtaining the hue value, saturation value and brightness value. In the HSV conversion program in FIG. 7, the value of digital image data, i.e. input image data is defined as InR, InG and InB, calculated hue value as OutH, of which scale is 0 to 360, saturation value as OutS, and brightness value as OutV, of which unit as 0 to 255.

Next, a two-dimensional histogram is generated by dividing the photographed image data into regions based on a combination of specified hue and brightness and calculating the accumulated number of pixels for each divided region (step S11). Division of the photographed image data into regions is described in detail hereunder.

Brightness (V) is divided into seven regions, each having the brightness value of 0 to 25 (v1), 26 to 50 (v2), 51 to 84 (v3), 85 to 169 (v4), 170 to 199 (v5), 200 to 224 (v6), and 225 to 255 (v7). Hue (H) is divided into four regions: skin-color hue region (H1 and H2), having the hue value of 0 to 39 and 330 to 359, green hue region (H3), having the hue value of 40 to 160, blue hue region (H4) having the hue value of 161 to 250, and red hue region (H5). Since the red hue region is known to have little contribution to the discrimination of photographed scene, it is not used in the calculation below. The skin-color hue region is further divided into a skin-colored region (H1) and other region (H2). Of the skin-color hue region (H=0 to 39, 330 to 359), the hue′ (H) that satisfies the expression (1) below is regarded as the skin-colored region (H1) and the region that does not satisfy the expression (1) is regarded (H2) in the description hereunder.
Hue′ (H)/Luminance (Y)<3.0×(Saturation (S)/255)+0.7 (1)
where 10<Saturation (S)<175,
Hue′ (H)=Hue (H)+60 (when 0≦Hue (H)<300),
Hue′ (H)=Hue (H)−300 (when 300≦Hue (H)<360),
Luminance Y=InR×0.30+InG×0.59+InB×0.11.

Accordingly, the number of divided regions of the photographed image data is 4×7=28. Brightness (V) can be used in the expression (1).

When the two-dimensional histogram is generated, the first occupation ratio representing the occupation ratio of the accumulated number of pixels calculated for each divided region in the total number of pixels (whole photographed image data (step S12), and now the occupation ratio calculation is complete. Given that the first occupation ratio calculated in a divided region based on a combination of the brightness region vi and hue region Hj is Rij, the first occupation ratio in each divided region can be indicated as shown in Table 1.

TABLE 1
[First Occupation ratio]

| | H1 | H2 | H3 | H4 |
|---|---|---|---|---|
| v1 | R11 | R12 | R13 | R14 |
| v2 | R21 | R22 | R23 | R24 |
| v3 | R31 | R32 | R33 | R34 |
| v4 | R41 | R42 | R43 | R44 |
| v5 | R51 | R52 | R53 | R54 |
| v6 | R61 | R62 | R63 | R64 |
| v7 | R71 | R72 | R73 | R74 |

Next, the calculation of the index 1 and index 2 is described hereunder.

Table 2 shows the first coefficient in each divided region needed for calculating the index 1 that quantitatively represents the probability of strobe-light photography obtained from the discriminant analysis, that is, the brightness condition of the face region in case of strobe-light photography. The coefficient for each divided region shown in Table 2 is the weight coefficient to be multiplied to the first occupation ratio Rij of each divided region shown in Table 1.

TABLE 2
[First Coefficient]

| | H1 | H2 | H3 | H4 |
|---|---|---|---|---|
| v1 | −44.0 | 0.0 | 0.0 | 0.0 |
| v2 | −16.0 | 8.6 | −6.3 | −1.8 |
| v3 | −8.9 | 0.9 | −8.6 | −6.3 |
| v4 | −3.6 | −10.8 | −10.9 | −7.3 |
| v5 | 13.1 | 20.9 | −25.8 | −9.3 |
| v6 | 8.3 | −11.3 | 0.0 | −12.0 |
| v7 | −11.3 | −11.1 | −10.0 | −14.6 |

The coefficient of each divided region can be obtained in the following steps, for example.

First, a plurality sets of image data is prepared for each of photographing conditions and two dimensional histograms are created by computing, on each image data, the accumulated number of pixels for each divided region based on a combination of predetermined brightness and hue. Each of an occupation ratio representing the ratio of the accumulated number of pixels to the total pixel number of the image, is calculated for each of the divided region. These calculated occupation ratios are used as discrimination factors of the discriminant function in a discriminant analysis method.

Next, the discriminant function includes the above discrimination factors and a discriminal coefficients, and the expectation value such that the plurality sets of image data are divided into groups corresponding to the photographing conditions are decided beforehand.

Discriminal coefficients such that each image data attains the above expectation value are defined by adjusting the discriminal coefficients. Each of the discriminal coefficients defined as above is to be used for weighting factor which multiplies to the occupation ratio of each divided region.

It can be verified whether the adjusted discriminal coefficients has appropriate values, by calculating again the occupation ratios for a new sample image and applying the computed occupation ratios (discrimination factors) and the above adjusted discrimination coefficients to the discriminant function.

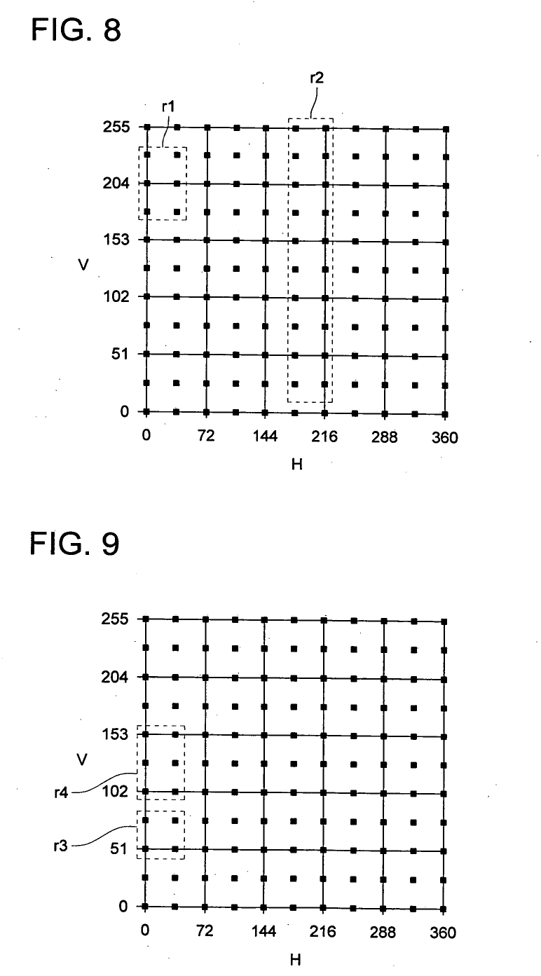

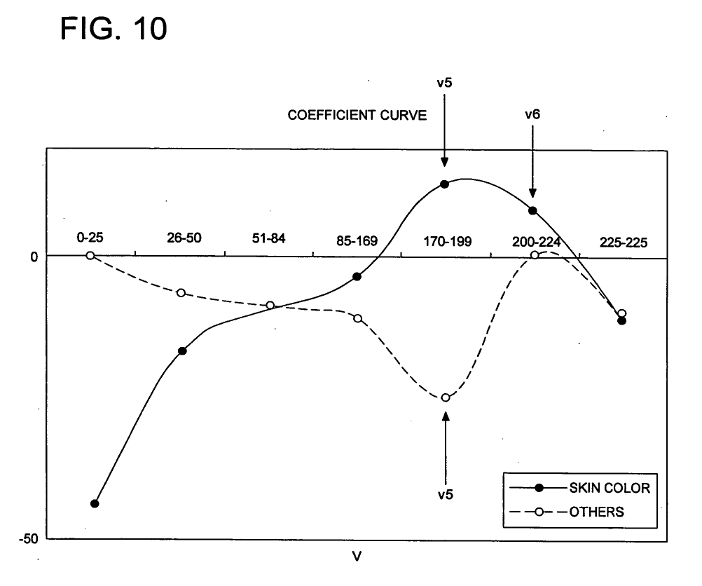

FIG. 8 shows a brightness (v)-hue (H) plane. According to Table 2, a positive (+) coefficient is used for the first occupation ratio calculated from the region (r1) distributed in the high-brightness skin-color hue region in FIG. 8 and a negative (−) coefficient is used for the first occupation ratio calculated from the blue hue region (r2) covering other hues. FIG. 10 shows the first coefficient in the skin-colored region (H1) and the first coefficient in other areas (green hue area (H3)) as a curve (coefficient curve) that continuously changes throughout the whole brightness. According to Table 2 and FIG. 10, the first coefficient in the skin-colored region (H1) is positive (+) and the first coefficient in other areas (for example, green hue area (H3)) is negative (−) in the high-brightness region (V=170 to 224), and it is understood that they have different signs.

Given that the first coefficient in the brightness region vi and hue region Hj is Cij, the sum of the Hk region for calculating the index 1 is defined as follows.

$$[ Expression 1 ] \\ Sum of Hk region = {\sum }_{i = 1}^{7} Rik \times Cik \qquad ( 2 )$$

Accordingly, the sum of each region H1 to H4 can be expressed by the following expression (2-1) to expression (2-4).
Sum of region H1=R11×(−44.0)+R21×(−16.0)+(ellipsis) . . . +R71×(−11.3) (2-1)
Sum of region H2=R12×0.0+R22×8.6+(ellipsis) . . . R72×(−11.1) (2-2)
Sum of region H3=R13×0.0+R23×(−6.3)+(ellipsis) . . . +R73×(−10.0) (2-3)
Sum of region H4=R14×0.0+R24×(−1.8°)+(ellipsis) . . . +R74×(−14.6) (2-4).

The index 1 is defined as in the expression (3), using the sum of each region H1 to H4 shown by the expression (2-1) to (2-4).
Index 1=Sum of region H1+Sum of region H2+Sum of region H3+Sum of region H4+4.424 (3).

Table 3 shows the second coefficient in each divided region needed for calculating the index 2 that quantitatively represents the probability of back lighting photography obtained from the discriminant analysis, that is, the brightness condition of the face region in case of back lighting photography.

The coefficient for each divided region shown in Table 3 is the weight coefficient to be multiplied to the first occupation ratio Rij of each divided region shown in Table 1.

TABLE 3
[Second Coefficient]

| | H1 | H2 | H3 | H4 |
|---|---|---|---|---|
| v1 | −27.0 | 0.0 | 0.0 | 0.0 |
| v2 | 4.5 | 4.7 | 0.0 | −5.1 |
| v3 | 10.2 | 9.5 | 0.0 | −3.4 |
| v4 | −7.3 | −12.7 | −6.5 | −1.1 |
| v5 | −10.9 | −15.1 | −12.9 | 2.3 |
| v6 | −5.5 | 10.5 | 0.0 | 4.9 |
| v7 | −24.0 | −8.5 | 0.0 | 7.2 |

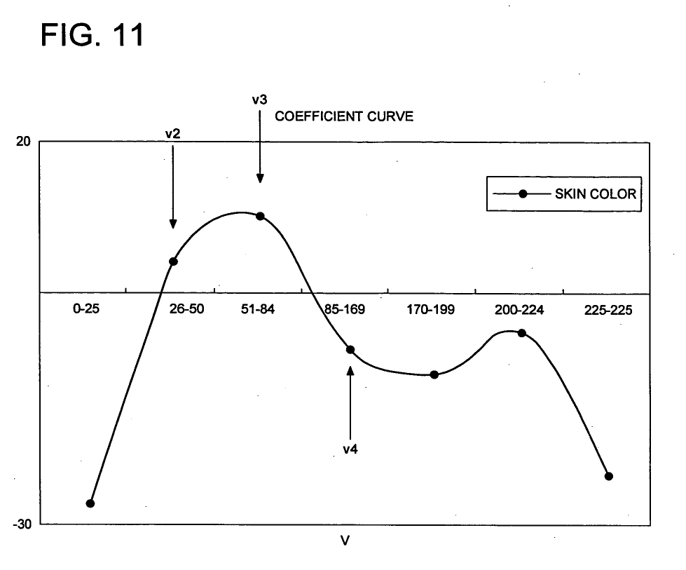

FIG. 9 shows a brightness (v)-hue (H) plane. According to Table 3, a negative (−) coefficient is used for the occupation ratio calculated from the region (r4) with the middle-brightness region and the skin-colored hue region in FIG. 9 and a positive (+) coefficient is used for the occupation ratio calculated from the low-brightness (shadow) region (r3) of the skin-colored hue region. FIG. 11 shows the second coefficient in the skin-colored region (H1) as a curve (coefficient curve) that continuously changes throughout the whole brightness. According to Table 3 and FIG. 11, the second coefficient in the middle-brightness region having the brightness value 85 to 169 (v4) in the skin-colored hue region is negative (−) and the second coefficient in the low-brightness (shadow) region having the brightness value 26 to 84 (v2, v3) is positive (+), and it is understood that they have different signs.

Given that the second coefficient in the brightness region vi and hue region Hj is Dij, the sum of the Hk region for calculating the index 2 is defined as follows.

$$[ Expression 2 ] \\ Sum of Hk region = {\sum }_{i = 1}^{7} Rik \times Dik \qquad ( 4 )$$

Accordingly, the sum of each region H1 to H4 can be expressed by the following expression (4-1) to expression (4-4).
Sum of region H1=R11×(−27.0)+R21×4.5+(ellipsis) . . . +R71×(−24.0) (4-1)
Sum of region H2=R12×0.0+R22×4.7+(ellipsis) . . . +R72×(−8.5) (4-2)
Sum of region H3=R13×0.0+R23×0.0+(ellipsis) . . . +R73×0.0 (4-3)
Sum of region H4=R14×0.0+R24×(−5.1)+(ellipsis) . . . +R74×7.2 (4-4).

The index 2 is defined as in the expression (5), using the sum of each region H1 to H4 shown by the expression (4-1) to (4-4).
Index 2=Sum of region H1+Sum of region H2+Sum of region H3+Sum of region H4+1.554 (5).

Now, the occupation ratio calculation for calculating the index 3 by the ratio calculator 712 is described in detail hereunder, using the flowchart in FIG. 12.

Firstly, the RGB value of the photographed image data is converted into the HSV color system (step S20). Next, a two-dimensional histogram is generated by dividing the photographed image data into regions with a combination of the distance from the frame edge of display of the photographed image and brightness and calculating the accumulated number of pixels for each divided region (step S21). Division of the photographed image data into regions is described in detail hereunder.

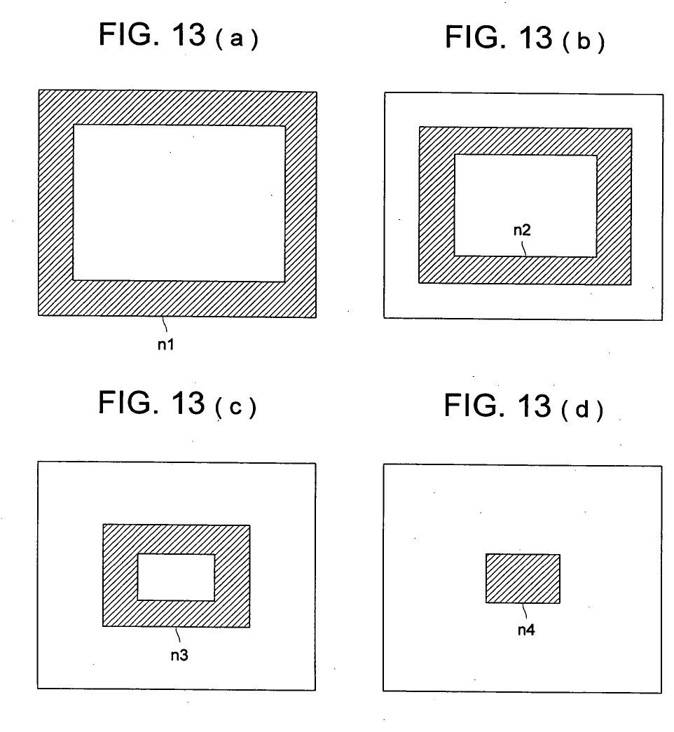

FIGS. 13 (a) to 13(d) shows four regions n1 to n4 divided in accordance with the distance from the frame edge of display of the photographed image data. The region n1 shown in FIG. 13 (a) is the frame, the region n2 shown in FIG. 13 (b) is a region inside the frame, the region n3 shown in FIG. 13 (c) is a region inside the region n2, and the region n2 shown in FIG. 13 (d) is the center region of the photographed image screen. The brightness is divided into seven regions v1 to v7 as above. Accordingly, when the photographed image data is divided into regions comprising a combination of the distance from the frame edge of the photographed image screen and brightness, the number of divided regions is 4×7=28.

When the two-dimensional histogram is generated, the second occupation ratio representing the occupation ratio of the accumulated number of pixels calculated for each divided region in the total number of pixels (whole photographed image data (step S22), and now the occupation ratio calculation is complete. Given that the second occupation ratio calculated in a divided region comprising a combination of the brightness region vi and screen region nj is Qij, the second occupation ratio in each divided region can be indicated as shown in Table 4.

TABLE 4
[Second Occupation ratio]

| | n1 | n2 | n3 | n4 |
|---|---|---|---|---|
| v1 | Q11 | Q12 | Q13 | Q14 |
| v2 | Q21 | Q22 | Q23 | Q24 |
| v3 | Q31 | Q32 | Q33 | Q34 |
| v4 | Q41 | Q42 | Q43 | Q44 |
| v5 | Q51 | Q52 | Q53 | Q54 |
| v6 | Q61 | Q62 | Q63 | Q64 |
| v7 | Q71 | Q72 | Q73 | Q74 |

Next, the calculation of the index 3 is described hereunder.

Table 5 shows the third coefficient in each divided region needed for calculating the index 3. The coefficient for each divided region shown in Table 4 is the weight coefficient to be multiplied to the second occupation ratio Qij of each divided region shown in Table 4.

TABLE 5
[Third Coefficient]

| | n1 | n2 | n3 | n4 |
|---|---|---|---|---|
| v1 | 40.1 | −14.8 | 24.6 | 1.5 |
| v2 | 37.0 | −10.5 | 12.1 | −32.9 |
| v3 | 34.0 | −8.0 | 0.0 | 0.0 |
| v4 | 27.0 | 2.4 | 0.0 | 0.0 |
| v5 | 10.0 | 12.7 | 0.0 | −10.1 |
| v6 | 20.0 | 0.0 | 5.8 | 104.4 |
| v7 | 22.0 | 0.0 | 10.1 | −52.2 |

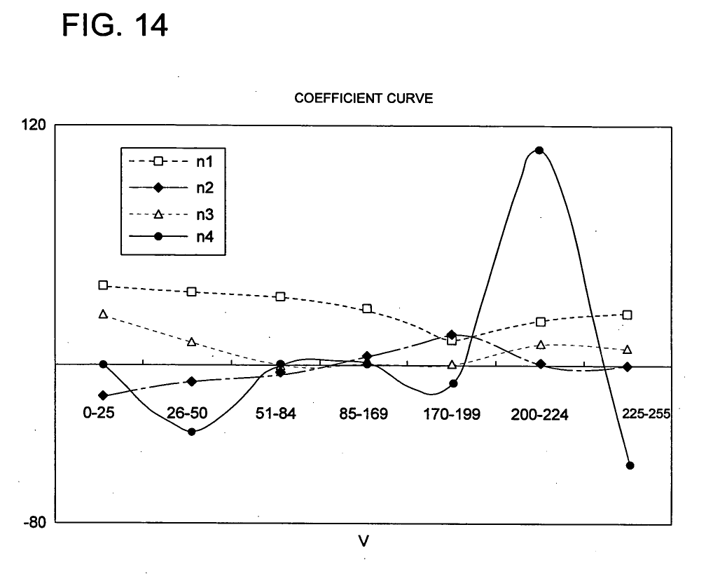

FIG. 14 shows the third coefficient in the screen region n1 to n4 as a curve (coefficient curve) that continuously changes throughout the whole brightness.

Given that the third coefficient in the brightness region vi and screen region nj is Eij, the sum of the nk region (screen region nk) for calculating the index 3 is defined as follows.

$$[ Expression 3 ] \\ Sum of nk region = {\sum }_{i = 1}^{7} Qik \times Eik \qquad ( 6 )$$

Accordingly, the sum of each region n1 to n4 can be expressed by the following expression (6-1) to expression (6-4).
Sum of region n1=Q11×40.1+Q21×37.0+(ellipsis) . . . Q71×22.0 (6-1)
Sum of region n2=Q12×(−14.8)+Q22×(−10.5)+(ellipsis) . . . +Q72×0.0 (6-2)
Sum of region n3=Q13×24.6+Q23×12.1+(ellipsis) . . . +Q73×10.1 (6-3)
Sum of region n4=Q14×1.5+Q24×(−32.9)+(ellipsis) . . . +Q74×(−52.2) (6-4).

The index 3 is defined as in the expression (7), using the sum of each region n1 to n4 shown by the expression (6-1) to (6-4).
Index 3=Sum of region n1+Sum of region n2+Sum of region n3+Sum of region n4−12.6201 (7).

The index 4 is defined as in the expression (8), using the index 1 and index 2, and the index 5 is defined as in the expression (9), using the indexes 1 to 3.
Index 4=0.565×Index 1+0.565×Index 3+0.457 (8)
Index 5=(−0.121)×Index 1+0.91×Index 2+0.113×Index 3−0.072 (9).

The weight coefficient to be multiplied to each index in the expressions (8) and (9) has been predetermined corresponding to the photographic condition.

Next, the discrimination of a photographed scene (light condition) is described hereunder.

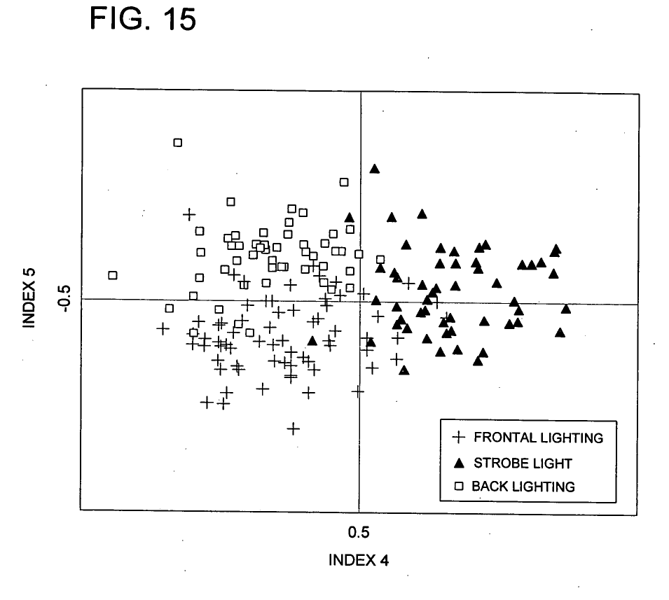

FIG. 15 shows plotted data of total 180 digital image data, where each 60 images are photographed under different light source conditions, frontal light, backlight and strobe-light, and the indexes 4 and 5 of each image data under different light source conditions are calculated and then plotted. According to FIG. 15, it is understood that more strobe-light scenes are observed when the index 4 is greater than 0.5 and that more back lighting scenes are observed when the index 4 is less than 0.5 and the index 5 is greater than −0.5. Table 6 shows the discrimination result of the photographed scene (light source condition) by the indexes 4 and 5.

TABLE 6

| | Index 4 | Index 5 |
|---|---|---|
| Frontal lighting | Not greater than 0.5 | Not greater than −0.5 |
| Backlighting | Not greater than 0.5 | Greater than −0.5 |
| Strobe light | Greater than 0.5 | — |

The photographed scene (light source condition) can be discriminated quantitatively by values of the indexes 4 and 5 as above.

Next, the calculation (determination) of the image processing condition for the photographed image data based on the discrimination result of the photographed scene is described hereunder. In the description below, it is assumed that the photographed image data has been converted to 16-bit and that the data unit of the photographed image data is 16-bit.

In calculating the image processing condition, the following parameters P1 to P9 are calculated first.
P1: Average luminance of whole photographic screen
P2: Average luminance of divided block
P3: Average luminance of skin-colored region (H1)
P4: Luminance correction variable 1=P1−P2
P5: Target correction variable of reproduction=Luminance reproduction target value (30360)−P4
P6: Offset 1=P5−P1
P7: Key correction variable
P8: Luminance correction variable 2
P9: Offset 2=P5−P8−P1.

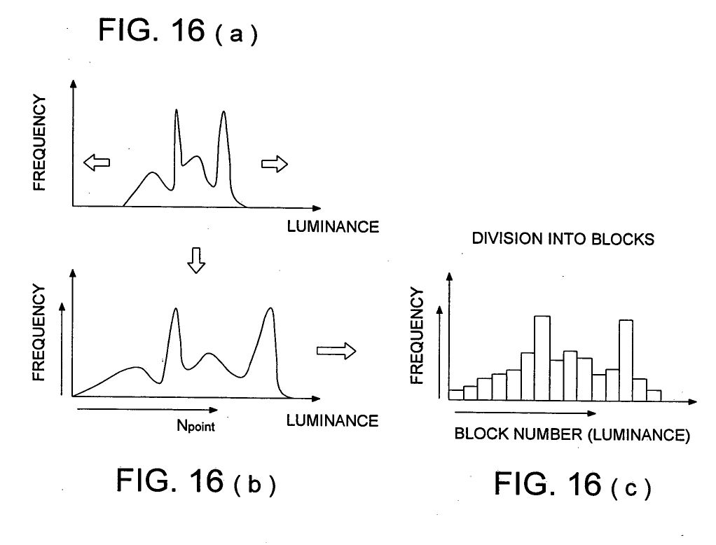

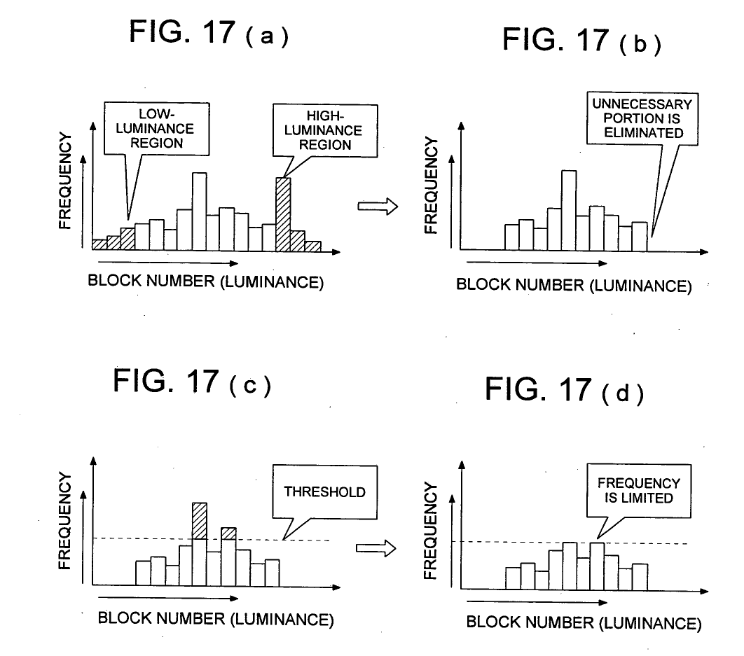

Calculation of the parameter P2 is described hereunder, using FIG. 16 and FIG. 17.

In order to normalize the photographed image data, a CDF (cumulative density function) is obtained. Next, the maximum and minimum are decided from the obtained CDF. The maximum and minimum shall be obtained for each RGB. The obtained maximum and minimum for each RGB are now named R max, R min, G max, G min, and B max, B min, respectively.

Next, normalized image date for an optional pixel (Rx, Gx, Bx) of the photographed image data is calculated. When the normalized data of Rx in the R plane is named Rₚₒᵢₙₜ, normalized data of Gx in the G plane is named Gₚₒᵢₙₜ, and normalized data of Bx in the B plane is named Bₚₒᵢₙₜ, the normalized data Rₚₒᵢₙₜ, Gₚₒᵢₙₜ and Bₚₒᵢₙₜ is shown by the following expressions (10) to (12).
Rₚₒᵢₙₜ={(RX−R min)/(R max−R min)}×65535 (10)
Gₚₒᵢₙₜ{(GX−G min)/(G max−G min)}×65535 (11)
Bₚₒᵢₙₜ={(BX−B min)/(B max−B min)}×65535 (12).
Next, the luminance Npoint of the pixel (Rx, Gx, Bx) is calculated from the expression (13).
Nₚₒᵢₙₜ=(Bₚₒᵢₙₜ+Gₚₒᵢₙₜ+Rₚₒᵢₙₜ)/3 (13).

FIG. 16 (a) shows the frequency distribution (histogram) of the luminance of RGB pixel before normalization. In FIG. 16 (a), the horizontal axis represents the luminance and vertical axis represents the frequency of pixel. This histogram is generated for each RGB. When the luminance histogram is generated, the photographed image data is normalized on each plane, using the expressions (10) to (12). FIG. 16 (b) is a luminance histogram calculated from the expression (13). Because the photographed image data has been normalized by 65535, each pixel becomes any value between the maximum 65535 and minimum 0.

When the luminance histogram in FIG. 16 (b) is divided into blocks by specified ranges, a frequency distribution as shown in FIG. 16 (c) is obtained. In FIG. 16 (c), the horizontal axis represents the block number (luminance) and the vertical axis represents the frequency.

Next, the highlight and shadow region elimination is performed, using the histogram in FIG. 16 (c). This is necessary because the average luminance is very high in a scene with white wall or on snow and the average luminance is very low in a scene under darkness, and consequently highlight and shadow region gives adverse impact on the average luminance control. Therefore, by limiting the highlight region and shadow region in the luminance histogram shown in FIG. 16 (c), the impact of these regions is decreased. If the high-luminance region (highlight region) and low-luminance region (shadow region) is eliminated from the histogram in FIG. 17 (a) (or in FIG. 16 (c)), the result is as shown in FIG. 17 (b).

Next, the area where the frequency is greater than the threshold in the luminance histogram is deleted as shown in FIG. 17 (c). This is necessary because, if any portion with extremely high frequency exists, data of this portion gives intense impact to the average luminance of the whole photographed image, and consequently erroneous correction may be caused. Therefore, the number of pixels exceeding the threshold is limited in the luminance histogram as shown in FIG. 17 (c). FIG. 17 (d) is a luminance histogram after limiting the number of pixels.

The parameter P2 is an average luminance calculated based on each block number and respective frequency of the luminance histogram (FIG. 17 (d)) obtained from a normalized histogram by eliminating the high-luminance region and low-luminance region and then limiting the number of pixels.

The parameter P1 is an average of the luminance of whole photographed image data and the parameter P3 is an average of the luminance of the skin-colored region (H1) in the photographed image data. The key correction variable as the parameter P7 and luminance correction variable as the parameter P8 are defined by the expression (14) and expression (15), respectively.
P7 (Key correction variable)=(P3−((Index 5/6)×10000)+3000)/24.78) (14)
P8 (Luminance correction variable 2)=(Index 4/6)×17500 (15).

The image processing condition (gradation conversion condition) of each photographed scene (light source condition) is described hereunder.

Under Frontal Lighting Condition:

When the photographed scene is under frontal lighting condition, an offset correction (parallel shifting of 8-bit value) is performed to match the parameter P1 with P5, using the expression (16) below.
RGB value of the output image=RGB value of the input image+P6 (16).
Under Backlighting Condition:

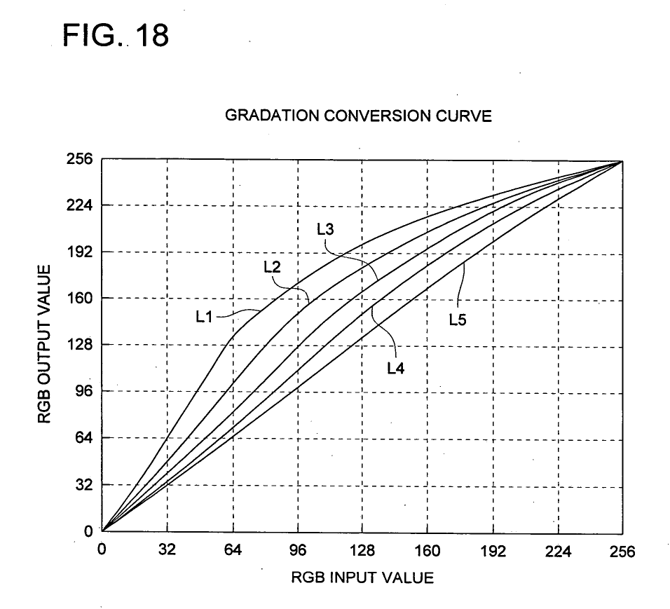

When the photographed scene is under backlighting condition, a gradation conversion curve corresponding to the parameter P7 (key correction value) shown in the expression (14) is selected from the predefined gradation conversion curves (correction curves) L1 to L5 shown in FIG. 18. The correlation between the value of the parameter 7 and selected gradation conversion curve is shown below.
When −0.5<P7<+0.5→L3
When +0.5≦P7<+1.5→L4
When +1.5≦P7<+2.5→L5
When −1.5<P7≦−0.5→L2
When −2.5<P7≦−1.5→L1

If the photographed scene is under back lighting condition, it is preferable to perform not only this gradation conversion but also dodging.

Under Strobe-Light Condition:

When the photographed scene is under strobe-light condition, an offset correction (parallel shifting of 8-bit value) is performed, using the expression (17) below.
RGB value of the output image=RGB value of the input image+P9 (17).

In this embodiment, when the gradation conversion is actually performed for a photographed image data, the above-mentioned image processing condition shall be changed from 16-bit to 8-bit.

If the process of the gradation adjustment drastically differs among the frontal light, backlight and strobe-light conditions, it is preferred to provide an intermediate region for smooth transition of the gradation adjustment process among the frontal lighting, back lighting and strobe-light conditions, because an adverse impact on the picture quality is predicted in case of erroneous discrimination of the photographed scene.

According to the image recording apparatus of this embodiment, it becomes possible to properly correct the brightness of the face region of an object by calculating an index that quantitatively represents a photographed scene (light source condition, (frontal light, backlight, or strobe-light)) from a photographed image data where the object is human body and determining the image processing condition of the photographed image data based on the calculated index.

Particularly by calculating the index 1 that quantitatively represents the probability of strobe-light photography, that is, the brightness condition of the face region in case of strobe-light photography, high-brightness region of the face region can be corrected properly.

In addition, by calculating the index 2 that quantitatively represents the probability of backlighting photography, that is, the brightness condition of the face region in case of backlighting photography, low-brightness region of the face region can be corrected properly.

Furthermore, by calculating the index 3 that quantitatively represents a type of the photographed scene from the screen composition and brightness distribution of the photographed image data, brightness region of the face region can be properly corrected.

Particularly by using the index 3 deduced from compositional element of the photographed image data in addition to using the index 1 and index 2, discrimination accuracy of photographed scene can improve.

The descriptions in this embodiment can be altered so far as the intent of the present invention is not lost.

For example, it is permissible to detect a face image from the photographed image data and discriminate a photographed scene based on the detected face image to determine the image processing condition. It is also permissible to employ Exif (Exchange image file format) information to discriminate a photographed scene. Use of Exif information makes it possible to further improve the discrimination accuracy of the photographed scene.

Although the photographed scene is discriminated based on the index 4 and index 5 in the above embodiment, it is permissible to use an additional index and discriminate the photographed scene in a three-dimensional space. If, for example, an under-lighted photographed scene is erroneously judged as a strobe-light scene, it is predicted that the image is processed to become darker. In order to avoid this, it is recommended that the average luminance P3 of the skin-colored region is specified as index 6, and whether a strobe-light or under-lighted photographed scene is discriminated using this index.

1. An image processing method of processing a set of image data corresponding to one frame of image, comprising the steps of:
an occupation ratio calculating step of
dividing the set of photographed image data into a plurality of regions based on at least one combination of a first combination of predefined brightness and hue; and a second combination of distance from a frame edge of the photographed image and brightness; and
calculating occupation ratios which represent an occupation ratio of each of the plurality of regions in the whole of the set of photographed image data;
an index calculating step of calculating an index determining a type of photographed scene by multiplying the occupation ratios calculated in the occupation ratio calculation step by coefficients predefined based on photographing conditions for the respective plurality of regions;
an image processing condition determining step of determining an image processing condition for the set of photographed image data based on the index calculated in the index calculating step.

2. The image processing method of claim 1,
wherein the occupation ratio calculating step
divides the set of photographed image data into a plurality of regions based on a combination of predefined brightness and hue and
calculates occupation ratios which represent an occupation ratio of each of the plurality of regions in a whole of the set of photographed image data and
the index calculating step calculates the index based on at least one of:
coefficients in which
a coefficient for a region including a predefined high-brightness region and a skin-colored hue region and
a coefficient for a region excluding a hue region of the region including the predefined high-brightness region and the skin-colored hue region
have different signs from each other; and
coefficients in which
a coefficient for a region including a predefined middle-brightness region and the skin-colored hue region and
a coefficient for a region excluding the predefined middle-brightness region;
have different signs from each other.

3. The image processing method of claim 2,
wherein the index calculating step uses the coefficients in which
the coefficient for the region including the predefined high-brightness region and the skin-colored hue region and
the coefficient for the region excluding the hue region of the region including the predefined high-brightness region and the skin-colored hue region
have different signs from each other.

4. The image processing method of claim 2,
wherein the index calculating step uses the coefficients in which
the coefficient for the region including the predefined middle-brightness region and the skin-colored hue region and
the coefficient for the region excluding the predefined middle-brightness region;
have different signs from each other.

5. The image processing method of claim 2,
wherein the index calculating step calculates a first index using coefficients in which
the coefficient for the region including the predefined high-brightness region and the skin-colored hue region and
the coefficient for the region excluding a hue region of the region including the predefined high-brightness region and the skin-colored hue region
have different signs from each other, and
calculates a second index using coefficients in which
the coefficient for the region including the predefined middle-brightness region and the skin-colored hue region and
the coefficient for the region excluding the predefined middle-brightness region
have different signs from each other, and
the image processing condition determining step determines the image processing condition based on the first index and the second index calculated in the index calculating step.

6. The image processing method of claim 2, further comprising:
a histogram generating step of generating a two dimensional histogram by calculating accumulated numbers of pixels of the set of photographed image data for respective combinations of predefined hue and brightness,
wherein the occupation ratio calculating step calculates the occupation ratios based on the two dimensional histogram.

7. The image processing method of claim 2,
wherein the region excluding the hue region of the region including the predefined high-brightness region and the skin-colored hue region whose coefficient has a different sign from the coefficient of the region including the predefined high-brightness region and a skin-colored hue region has a brightness region which is the predefined high-brightness region.

8. The image processing method of claim 2,
wherein the region excluding the predefined middle-brightness region whose coefficient has a different sign from the coefficient of the region including the predefined middle-brightness region and the skin-colored hue region has a hue region which is within the skin-colored hue region.

9. The image processing method of claim 2,
wherein the region including the predefined high-brightness region and the skin-colored hue region includes a region whose brightness value in HSV color system is in a range of 170 to 224.

10. The image processing method of claim 2,
wherein the region including the predefined middle-brightness region includes a region whose brightness value in HSV color system is in a range of 85 to 169.

11. The image processing method of claim 2,
wherein the region excluding the predefined high-brightness region and the skin-colored hue region has a hue region including at least one of a blue hue region and a green hue region.

12. The image processing method of claim 2,
wherein the region excluding the predefined middle-brightness region is a shadow region.

13. The image processing method of claim 11,
wherein a brightness value in HSV color system of the blue hue region is in a range of 161 to 250 and
a brightness value in HSV color system of the green hue region is in a range of 40 to 160.

14. The image processing method of claim 12,
wherein a brightness value in HSV color system of the shadow region is in a range of 26 to 84.

15. The image processing method of claim 2,
wherein a hue value in HSV color system of the skin-colored hue region is in a range of 0 to 39 and 330 to 359.

16. The image processing method of claim 2,
wherein the skin colored hue region is divided into two regions by a predefined conditional expression based on brightness and saturation.

17. The image processing method of claim 1,
wherein the occupation ratio calculating step
divides a set of photographed image data into a plurality of regions based on a combination of distance from an frame edge of the set of photographed image data and brightness and
calculates an occupation ratios which represent a occupation ratio of each of the plurality of regions in a whole of the set of photographed image data and
the index calculating step calculates the index based on coefficients having different values according to distance from the frame edge.

18. The image processing method of claim 17, further comprising:
a histogram generating step of generating a two dimensional histogram by calculating accumulated numbers of pixels of the set of photographed image data for respective combinations of predefined hue and brightness,
wherein the occupation ratio calculating step calculates the occupation ratios based on the two dimensional histogram.

19. The image processing method of claim 1,
wherein the occupation ratio calculating step
divides the set of photographed image data into a plurality of regions based on a combination of predefined brightness and hue,
calculates first occupation ratios which represent an occupation ratio of each of the plurality of regions in a whole of the set of photographed image data,
divides the set of photographed image data into a plurality of regions based on a combination of distance from a frame edge of the set of photographed image data and brightness and
calculates second occupation ratios which represent an occupation ratio of each of the plurality of regions in a whole of the set of photographed image data,
the index calculating step calculates the index determining a type of photographed scene by multiplying each of the first and second occupation ratios calculated in the occupation ratio calculation step by each of coefficients predefined based on photographing conditions,
the index calculating step further calculates:
a first index using coefficients in which the coefficient for the region including the predefined high-brightness region and the skin-colored hue region and
the coefficient for the region excluding a hue region of the region including the predefined high-brightness region and the skin-colored hue region
have different signs from each other;
a second index using coefficients in which coefficients in which
a coefficient for the region including the predefined middle-brightness region and the skin-colored hue region and
a coefficient for the region excluding the predefined middle-brightness region;
have different signs from each other; and
the third index using coefficients having different values according to distance from the edge, and
the image processing condition determining step determines the image processing condition based on the first to third indexes calculated in the index calculating step.

20. The image processing method of claim 19,
wherein the index calculating step calculates a fourth index and a fifth index by multiplying the first to third indexes by coefficients predefined based on photographed scene respectively and combining products of the first to third indexes and the coefficients, and
the image processing condition determining step determines the image processing condition based on the fourth index and the fifth index calculated in the index calculating step.

21. The image processing method of claim 19, further comprising:
a histogram generating step of generating a two dimensional histogram by calculating accumulated numbers of pixels of the set of photographed image data for respective combinations of distance from an frame edge of the set of photographed image data and brightness,
wherein the occupation ratio calculating step calculates the occupation ratios based on the two dimensional histogram.

22. The image processing method of claim 19 further comprising:
a histogram generating step of generating a two dimensional histogram by calculating accumulated numbers of pixels of the set of photographed image data for respective combinations of predefined hue and brightness,
wherein the occupation ratio calculating step calculates the occupation ratios based on the two dimensional histogram.

23. The image processing method of claim 19,
wherein the region excluding the hue region of the region including the predefined high-brightness region and the skin-colored hue region whose coefficient has a different sign from the coefficient of the region including the predefined high-brightness region and a skin-colored hue region has a brightness region which is the predefined high-brightness region.

24. The image processing method of claim 19,
wherein the region excluding the predefined middle-brightness region whose coefficient has a different sign from the coefficient of the region including the predefined middle-brightness region and the skin-colored hue region has a hue region which is within the skin-colored hue region.

25. The image processing method of claim 19,
wherein the region including the predefined high-brightness region and the skin-colored hue region includes a region whose brightness value in HSV color system is in a range of 170 to 224.

26. The image processing method of claim 19,
wherein the region including the predefined middle-brightness region includes a region whose brightness value in HSV color system is in a range of 85 to 169.

27. The image processing method of claim 19,
wherein the region excluding the predefined high- brightness region and the skin-colored hue region has a hue region including at least one of a blue hue region and a green hue region.

28. The image processing method of claim 19,
wherein the region excluding the predefined middle-brightness region is a shadow region.

29. The image processing method of claim 27,
wherein a brightness value in HSV color system of the blue hue region is in a range of 161 to 250 and
a brightness value in HSV color system of the green hue region is in a range of 40 to 160.

30. The image processing method of claim 28,
wherein a brightness value in HSV color system of the shadow region is in a range of 26 to 84.

31. The image processing method of claim 19,
wherein a hue value in HSV color system of the skin-colored hue region is in a range of 0 to 39 and 330 to 359.

32. The image processing method of claim 19,
wherein the skin colored hue region is divided into two regions by a predefined conditional expression based on brightness and saturation.

33. The image processing method of claim 1,
wherein the image processing condition determining step determines the image processing condition for applying a gradation converting processing to the set of photographed image data.

34. The image processing method of claim 1,
wherein the coefficients predefined based on photographing conditions are a discriminal coefficients calculated by a discriminant analysis method.

35. The image processing method of claim 34,
wherein the coefficients predefined based on photographing conditions are values of discriminal coefficients regulated such that a discriminal function satisfies a predefined condition for each of a plural sets of sample image corresponding to the photographing conditions.

36. An image processing apparatus for processing a set of image data corresponding to one frame of image, comprising:
an occupation ratio calculating section for
dividing the set of photographed image data into a plurality of regions based on at least one combination of a first combination of predefined brightness and hue; and a second combination of distance from a frame edge of the photographed image and brightness; and
calculating occupation ratios which represent an occupation ratio of each of the plurality of regions in the whole of the set of photographed image data;
an index calculating section for calculating an index determining a type of photographed scene by multiplying the occupation ratios calculated in the occupation ratio calculation step by coefficients predefined based on photographing conditions for the respective plurality of regions;
an image processing condition determining section for determining an image processing condition for the set of photographed image data based on the index calculated in the index calculating section.

37. The image processing apparatus of claim 36,
wherein the occupation ratio calculating section
divides a set of photographed image data into a plurality of regions based on a combination of predefined brightness and hue and
calculates an occupation ratio which represents an occupation ratio of each of the plurality of regions in a whole of the set of photographed image data and
the index calculating section determines the index based on at least one of:
coefficients in which
a coefficient for the region including the predefined high-brightness region and a skin-colored hue region and
a coefficient for a region excluding a hue region of the predefined high-brightness region and the skin-colored hue region
have different signs from each other; and
coefficients in which
a coefficient for the region including the predefined middle-brightness region and the skin-colored hue region and
a coefficient for the region excluding a brightness region of the predefined middle-brightness region;
have different signs from each other.

38. The image processing apparatus of claim 37,
wherein the index calculating section uses the coefficients in which
the coefficient for the region including the predefined high-brightness region and a skin-colored hue region and
the coefficient for a region excluding a hue region of the region including the predefined high-brightness region and the skin-colored hue region
have different signs from each other.

39. The image processing apparatus of claim 37,
wherein the index calculating section uses the coefficients in which
the coefficient for the region including the predefined middle-brightness region and the skin-colored hue region and
the coefficient for the region excluding a brightness region of the predefined middle-brightness region;
have different signs from each other.

40. The image processing apparatus of claim 37,
wherein the index calculating section calculates a first index using coefficients in which
the coefficient for the region including the predefined high-brightness region and the skin-colored hue region and
the coefficient for the region excluding a hue region of the region including the predefined high-brightness region and the skin-colored hue region
have a different sign from each other, and
calculates a second index using coefficients in which
the coefficient for the region including the predefined middle-brightness region and the skin-colored hue region and
the coefficient for the region excluding a brightness region of the predefined middle-brightness region
have a different sign from each other,
the image processing condition determining section determines the image processing condition based on the first index and the second index calculated in the index calculating section.

41. The image processing apparatus of claim 36,
wherein the occupation ratio calculating section
divides a set of photographed image data into a plurality of regions based on a combination of distance from an frame edge of the set of photographed image data and brightness and
calculates an occupation ratio which represents a occupation ratio of each of the plurality of regions in a whole of the set of photographed image data and
the index calculating section calculates the index based on coefficients having different values according to distance from the edge.

42. The image processing apparatus of claim 36,
wherein the occupation ratio calculating section
divides a set of photographed image data into a plurality of regions based on a combination of predefined brightness and hue,
calculates a first occupation ratio which represents an occupation ratio of each of the plurality of regions in a whole of the set of photographed image data,
divides a set of photographed image data into a plurality of regions based on a combination of distance from a frame edge of the set of photographed image data and brightness and
calculates a second occupation ratio which represents an occupation ratio of each of the plurality of regions in a whole of the set of photographed image data,
the index calculating section calculates the index determining a type of a photographed scene by multiplying each of the first and second occupation ratios of each of the plurality of area calculated in the occupation ratio calculation section by a predefined index according to a photographing condition,
the index calculating section further calculates:
a first index using coefficients in which the coefficient for the region including the predefined high-brightness region and the skin-colored hue region and
the coefficient for the region excluding a hue region of the region including the predefined high-brightness region and the skin-colored hue region
have a different sign from each other;
a second index using coefficients in which coefficients in which
a coefficient for the region including the predefined middle-brightness region and the skin-colored hue region and
a coefficient for the region excluding a brightness region of the predefined middle-brightness region;
have different signs from each other,
the third index using coefficients having different values according to distance from the edge, and
the image processing condition determining section determines the image processing condition based on the first to third indexes calculated in the index calculating section.

43. An image recording apparatus for processing a set of image data corresponding to one frame of image, comprising:
an occupation ratio calculating section for
dividing the set of photographed image data into a plurality of regions based on at least one combination of a first combination of predefined brightness and hue; and a second combination of distance from a frame edge of the photographed image and brightness; and
calculating occupation ratios which represent an occupation ratio of each of the plurality of regions in the whole of the set of photographed image data;
an index calculating section for calculating an index determining a type of photographed scene by multiplying the occupation ratios calculated in the occupation ratio calculation step by coefficients predefined based on photographing conditions for the respective plurality of regions;
an image processing condition determining section for determining an image processing condition for the set of photographed image data based on the index calculated in the index calculating section;
an image processing section for applying image processing to the set of photographed image data based on the image processing condition determined in the image processing condition determining section;
an image data generating section for generating an image data applied the image processing in the image processing section on an output medium.

44. The image recording apparatus of claim 43,
wherein the occupation ratio calculating section
divides a set of photographed image data into a plurality of regions based on a combination of predefined brightness and hue and
calculates an occupation ratio which represents an occupation ratio of each of the plurality of regions in a whole of the set of photographed image data and
the index calculating section determines the index based on at least one of:
coefficients in which
a coefficient for the region including the predefined high-brightness region and a skin-colored hue region and
a coefficient for a region excluding a hue region of the region including the predefined high-brightness region and the skin-colored hue region
have different signs from each other; and
coefficients in which
a coefficient for the region including the predefined middle-brightness region and the skin-colored hue region and
a coefficient for the region excluding a brightness region of the predefined middle-brightness region;
have different signs from each other.

45. The image recording apparatus of claim 44,
wherein the index calculating section uses the coefficients in which
the coefficient for the region including the predefined high-brightness region and a skin-colored hue region and
the coefficient for a region excluding a hue region of the region including the predefined high-brightness region and the skin-colored hue region
have different signs from each other.

46. The image recording apparatus of claim 44,
wherein the index calculating section uses the coefficients in which
the coefficient for the region including the predefined middle-brightness region and the skin-colored hue region and
the coefficient for the region excluding a brightness region of the predefined middle-brightness region;
have different signs from each other.

47. The image recording apparatus of claim 44,
wherein the index calculating section calculates a first index using coefficients in which
the coefficient for the region including the predefined high-brightness region and the skin-colored hue region and
the coefficient for the region excluding a hue region of the region including the predefined high-brightness region and the skin-colored hue region
have a different sign from each other, and
calculates a second index using coefficients in which
the coefficient for the region including the predefined middle-brightness region and the skin-colored hue region and
the coefficient for the region excluding a brightness region of the predefined middle-brightness region
have a different sign from each other,
the image processing condition determining section determines the image processing condition based on the first index and the second index calculated in the index calculating section.

48. The image recording apparatus of claim 43,
wherein the occupation ratio calculating section
divides a set of photographed image data into a plurality of regions based on a combination of distance from an frame edge of the set of photographed image data and brightness and
calculates an occupation ratio which represents a occupation ratio of each of the plurality of regions in a whole of the set of photographed image data and
the index calculating section calculates the index based on coefficients having different values according to distance from the edge.

49. The image recording apparatus of claim 43,
wherein the occupation ratio calculating section
divides a set of photographed image data into a plurality of regions based on a combination of predefined brightness and hue,
calculates a first occupation ratio which represents an occupation ratio of each of the plurality of regions in a whole of the set of photographed image data,
divides a set of photographed image data into a plurality of regions based on a combination of distance from a frame edge of the set of photographed image data and brightness and
calculates a second occupation ratio which represents an occupation ratio of each of the plurality of regions in a whole of the set of photographed image data,
the index calculating section calculates the index determining a type of a photographed scene by multiplying each of the first and second occupation ratios of each of the plurality of area calculated in the occupation ratio calculation section by a predefined index according to a photographing condition,
the index calculating section further calculates:
a first index using coefficients in which the coefficient for the region including the predefined high-brightness region and the skin-colored hue region and
the coefficient for the region excluding a hue region of the region including the predefined high-brightness region and the skin-colored hue region
have a different sign from each other;
a second index using coefficients in which coefficients in which
a coefficient for the region including the predefined middle-brightness region and the skin-colored hue region and
a coefficient for the region excluding a brightness region of the predefined middle-brightness region;
have different signs from each other,
the third index using coefficients having different values according to distance from the edge, and
the image processing condition determining section determines the image processing condition based on the first to third indexes calculated in the index calculating section.

50. An image processing program of processing a set of image data corresponding to one frame of image, comprising the steps of:
an occupation ratio calculating step of
dividing the set of photographed image data into a plurality of regions based on at least one combination of a first combination of predefined brightness and hue; and a second combination of distance from a frame edge of the photographed image and brightness; and
calculating occupation ratios which represent an occupation ratio of each of the plurality of regions in the whole of the set of photographed image data;
an index calculating step of calculating an index determining a type of photographed scene by multiplying the occupation ratios calculated in the occupation ratio calculation step by coefficients predefined based on photographing conditions for the respective plurality of regions;
an image processing condition determining step of determining an image processing condition for the set of photographed image data based on the index calculated in the index calculating step.

51. The image processing program of claim 50,
wherein the occupation ratio calculating step
divides a set of photographed image data into a plurality of regions based on a combination of predefined brightness and hue and
calculates an occupation ratio which represents an occupation ratio of each of the plurality of regions in a whole of the set of photographed image data and
the index calculating step determines the index based on at least one of:
coefficients in which
a coefficient for the region including the predefined high-brightness region and a skin-colored hue region and
a coefficient for a region excluding a hue region of the region including the predefined high-brightness region and the skin-colored hue region
have different signs from each other; and
coefficients in which
a coefficient for the region including the predefined middle-brightness region and the skin-colored hue region and
a coefficient for the region excluding a brightness region of the predefined middle-brightness region;
have different signs from each other.

52. The image processing program of claim 51,
wherein the index calculating step uses the coefficients in which
the coefficient for the region including the predefined high-brightness region and a skin-colored hue region and
the coefficient for a region excluding a hue region of the region including the predefined high-brightness region and the skin-colored hue region
have different signs from each other.

53. The image processing program of claim 51,
wherein the index calculating step uses the coefficients in which
the coefficient for the region including the predefined middle-brightness region and the skin-colored hue region and
the coefficient for the region excluding a brightness region of the predefined middle-brightness region;
have different signs from each other.

54. The image processing program of claim 51,
wherein the index calculating step calculates a first index using coefficients in which
the coefficient for the region including the predefined high-brightness region and the skin-colored hue region and
the coefficient for the region excluding a hue region of the region including the predefined high-brightness region and the skin-colored hue region
have a different sign from each other, and
calculates a second index using coefficients in which
the coefficient for the region including the predefined middle-brightness region and the skin-colored hue region and
the coefficient for the region excluding a brightness region of the predefined middle-brightness region
have a different sign from each other,
the image processing condition determining step determines the image processing condition based on the first index and the second index calculated in the index calculating step.

55. The image processing program of claim 50,
wherein the occupation ratio calculating step
divides a set of photographed image data into a plurality of regions based on a combination of distance from an frame edge of the set of photographed image data and brightness and
calculates an occupation ratio which represents a occupation ratio of each of the plurality of regions in a whole of the set of photographed image data and
the index calculating step calculates the index based on coefficients having different values according to distance from the edge.

56. The image processing program of claim 50,
wherein the occupation ratio calculating step
divides a set of photographed image data into a plurality of regions based on a combination of predefined brightness and hue,
calculates a first occupation ratio which represents an occupation ratio of each of the plurality of regions in a whole of the set of photographed image data,
divides a set of photographed image data into a plurality of regions based on a combination of distance from a frame edge of the set of photographed image data and brightness and
calculates a second occupation ratio which represents an occupation ratio of each of the plurality of regions in a whole of the set of photographed image data,
the index calculating step calculates the index determining a type of a photographed scene by multiplying each of the first and second occupation ratios of each of the plurality of area calculated in the occupation ratio calculation step by a predefined index according to a photographing condition,
the index calculating step further calculates:
a first index using coefficients in which the coefficient for the region including the predefined high-brightness region and the skin-colored hue region and
the coefficient for the region excluding a hue region of the region including the predefined high-brightness region and the skin-colored hue region
have a different sign from each other;
a second index using coefficients in which coefficients in which
a coefficient for the region including the predefined middle-brightness region and the skin-colored hue region and
a coefficient for the region excluding a brightness region of the predefined middle-brightness region;
have different signs from each other,
the third index using coefficients having different values according to distance from the edge, and
the image processing condition determining step determines the image processing condition based on the first to third indexes calculated in the index calculating step.
